(19) United States
(12) Patent Application Publication
(10) Pub. No.: US 2026/0221648 A1
(43) Pub. Date: Jul. 30, 2026

(54) SPACE-BASED RADAR VIA CONSTELLATION LOW EARTH ORBIT (LEO) SATELLITES IMPLEMENTING THIN-FILM PHASED ARRAY ANTENNA SYSTEMS

(71) Applicant: WILDSTAR, LLC, ARLINGTON, TX (US)

(72) Inventor: Gregory Thane Wyler, Stuart, FL (US)

(73) Assignee: WILDSTAR, LLC, Arlington, TX (US)

(21) Appl. No.: 19/574,251

(22) Filed: Mar. 20, 2026

Related U.S. Application Data
(63) Continuation-in-part of application No. 18/715,030, filed on Dec. 23, 2022.
(60) Provisional application No. 63/293,616, filed on Dec. 23, 2021.
(60) Provisional application No. 63/776,008, filed on Mar. 21, 2025.

(51) Int. Cl. H01Q 1/28; G01S 19/42; H01Q 3/38; H01Q 5/20

(52) U.S. Cl. CPC H01Q 1/288; G01S 19/42; H01Q 3/38; H01Q 5/20

(57) ABSTRACT

A space-based radar system is provided that includes a constellation of low Earth orbit (LEO) satellites forming a distributed radar network that provides seamless global radar coverage. Each LEO satellite includes a phased array antenna system that enables electronic beam steering. The LEO satellites leverage advanced digital beamforming (DBF) technologies to dynamically steer and shape beams in real time, improving resolution, coverage, and adaptability. The LEO satellites may communicate with each other and ground stations using inter-satellite links (ISLs), which allows the satellites to share data with each other in real-time or near-real-time. As such, satellites can process data from other satellites and fuse it to improve coverage and target tracking. The constellation of LEO satellites can lock multi-beam phased-array radars onto targets from multiple satellites, which allows the system to paint a target from multiple directions with long-wavelength radar from multiple satellites at the same time. The disclosed LEO satellites can operate in an ultra-high frequency (UHF) band of radio frequencies, which allows the disclosed radar systems to operate through any weather conditions and penetrate dense foliage, buildings, and water to detect objects and targets that might otherwise be obscured from conventional radar systems.

### CROSS REFERENCE TO RELATED APPLICATIONS

This application is a continuation-in-part of U.S. application Ser. No. 18/715,030, filed May 30, 2024, now published as US2025/0038425A1, titled STRUCTURAL ELEMENT HAVING THIN FILM SOLAR CELLS AND THEN FILM ANTENNA ELEMENTS, which is a national stage entry of International Application No. PCT Application No. PCT/US2022/054005, filed Dec. 23, 2022 titled STRUCTURAL ELEMENT HAVING THIN FILM SOLAR CELLS AND THIN FILM ANTENNA ELEMENTS, which claims the benefit of U.S. Provisional Application No. 63/293,616, filed Dec. 23, 2021 titled SATELLITE HAVING INFLATABLE ELEMENTS, which is a hereby incorporated by reference in its entirety.

This application claims priority to U.S. Provisional Application No. 63/776,008, titled SPACE-BASED PHASED ARRAY RADAR, filed Mar. 21, 2025, which is hereby incorporated by reference in its entirety.

### TECHNICAL FIELD

The present disclosure relates to radar systems, and more particularly to space-based radar systems that are implemented via a constellation of LEO satellites having thin-film phased array antenna systems.

### BACKGROUND

Recently there has been interest in developing space-based radar systems including those that are implemented using Low Earth Orbit (LEO) satellite constellations. Examples are described in Tian et al., “Digital Beamforming Techniques for Spaceborne Phased-Array SAR,” IEEE Transactions on Geoscience and Remote Sensing, 2020; Zhang, Y., Li, X., Wang, J., & Liu, H., and “LEO-based satellite constellation for moving target detection,” Remote Sensing, 2020.

The development of such space-based radar systems presents a number of challenges. For example, power limitations are a significant challenge for LEO satellite radar systems, as phased array antennas require substantial energy for transmission, constrained by solar panels and onboard batteries. This restricts the radar's duty cycle, reducing observation time and resolution. Interference and clutter pose another issue, as digital beamforming (DBF) enhances radar flexibility but increases susceptibility to ground-based interference, reflections from space debris, and multipath clutter in urban or maritime environments. The massive data generated by phased array radar systems, particularly when using DBF, creates downlink bottlenecks and processing delays. In addition, detecting low radar cross-section (RCS) objects such as stealth aircraft, hypersonic vehicles, and space debris remains difficult. Another issue is that LEO satellites encounter problems when obstructions or obstacles are introduced in the path between the satellites and objects that are being detected, observed and tracked. Additionally, the complexity and size of LEO satellites is prohibitive, not to mention the cost of deploying a large network of these LEO satellites in space. Addressing these challenges will be beneficial for advancing LEO radar systems. As such, it would be desirable to provide improved space-based radar systems.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The disclosed embodiments relate to space-based radar systems that are implemented via a constellation of LEO satellites having thin-film phased array antenna systems.

According to an aspect of the present disclosure, a space-based radar system is provided that includes a large constellation of low Earth orbit (LEO) satellites that operate cooperatively to provide global radar coverage to any point on or near Earth. The LEO satellites may include thin-film phased array antenna systems. For example, in one non-limiting implementation, a space-based radar system may include approximately 300 satellites or more in LEO (e.g., at or around 720 kilometers). As will be described below, this can provide multiple satellite coverage at any point on or near the Earth to enable a distributed array radar that can provide global coverage. In some aspects, having multiple satellites simultaneously visible from any given point on or near Earth may allow the satellites to function cooperatively as a distributed array radar, with each satellite contributing radar observations from different angles and positions. This multi-angle coverage can ensure that no location on Earth falls outside the combined field of view of the constellation, and the radar data from multiple satellites may be combined to enhance detection, tracking, and imaging capabilities.

According to other aspects of the present disclosure, each of the LEO satellites can include a very large aperture (VLA) phased array antenna configured for radar operations that includes an array of thin-film antenna elements; an onboard signal processing system; a transmitter; a receiver; and a digital beamforming processor, which may be part of the onboard signal processing system or a separate processor. Each of the array of thin-film antenna elements may be driven by a respective digital-to-analog converter (DAC) coupled to a power amplifier (PA) for transmitting the radar signals. For example, each radiating antenna element may have an associated DAC that converts the digital signal to be transmitted to an analog waveform that is then amplified by an associated power amplifier (PA) that can radiate several watts of power. Further, each of the array of thin-film antenna elements may be coupled to a respective low-noise amplifier (LNA) and an analog-to-digital converter (ADC) to digitize received signals. For example, each antenna element may also have an associated LNA that can be switched to the antenna (when the power amplifier is off), and the signals from the LNAs can be sampled by an associated ADC and converted to digital signals.

According to other aspects of the present disclosure, the onboard signal processing system may be coupled to each of the array of thin-film antenna elements via a respective high-speed data link (e.g., a high-speed data interconnect configured to transfer digitized signal data between the antenna elements and the digital beamforming processor, such as thin fiber optic cabling or high frequency digital wiring). For example, in one implementation, the respective high-speed data links comprise fiber optic links to minimize latency and reduce electromagnetic interference (EMI).

According to other aspects of the present disclosure, each VLA phased array antenna comprises: a ground plane, and an array of thin-film antenna elements mounted on a carrier layer, which in one embodiment, may be part of a multilayer structural element. Each VLA phased array antenna is ultra-thin and ultra-lightweight (e.g., has a mass that is less than or equal to 10 kilograms). This low mass may be achieved through the use of thin-film materials for the antenna elements, lightweight polymer films for the carrier layer and supporting layer (such as polyethylene terephthalate (PET) film, nylon film, mylar film, polyamide film, or polyimide film), thin conductive layers (such as metalized layers) for the ground plane, and printed conductive ink electrodes rather than heavier conventional antenna structures. Each VLA phased array antenna has a large number (e.g., 1000 or more) of thin-film antenna elements that are distributed over a large area (e.g., an area 420 m² or more when deployed).

According to other aspects of the present disclosure, the carrier layer can be part of the multilayer structural element that is part of the LEO satellite. In one embodiment, the multilayer structural element may be deployed via a deployable support structure. The structural element may be in a folded or rolled configuration prior to deployment. In one implementation, the deployable support structure may include carbon fiber booms that extend from a compact launch configuration to deploy the multilayer structural element (including VLA phased array and the ground plane) by uncurling to form a rigid support structure when deployed that holds the VLA phased array and the ground plane in place. In one embodiment, the multi-layer structural element has a first side and a second side opposite the first side, where the first side comprises a plurality of electrodes (each of which functions as one of the thin-film antenna elements) formed on the carrier layer, and where the second side comprises a support substrate that is separable from the electrodes by a specific separation distance and serves as the ground plane for the antenna element. In one implementation, the electrode may be printed on the carrier layer using a conductive ink in various shapes, for example, as a conductive spiral.

In one implementation, the support substrate is configured to support an optional thin-film solar panel system. The thin-film solar panel system and the electrode can be flexible. In one implementation, the support substrate may include a supporting layer (e.g., where the thin-film solar panel system overlies one surface of the supporting layer), and a thin conductive layer that overlies another surface of the supporting layer. The thin conductive layer may serve as the ground plane of the antenna element. For instance, in one implementation, the thin conductive layer may be a metalized layer, and the supporting layer and the carrier layer may each comprise one or more of: polyethylene terephthalate (PET) film, a nylon film, a mylar film, a polyamide film, and a polyimide film.

As will be explained in greater detail below, the onboard signal processing system may be configured to execute signal processing algorithms. For example, in one embodiment, the onboard signal processing system is configured to execute deep signal processing (DSP) algorithms. Deep signal processing is an advanced approach to signal processing that integrates machine learning (ML), artificial intelligence (AI), and deep neural networks (DNNs) to enhance traditional signal processing techniques. It is particularly useful for extracting meaningful insights from complex signals in radar system, for example.

Each of the thin-film antenna elements is configured to transmit and receive electromagnetic signals. The transmitter may be configured to generate and transmit a linear frequency modulated radar signals (e.g., pulses) from the array of thin-film antenna elements toward the Earth's surface, while the receiver may be configured to receive reflected radar signals from the array of thin-film antenna elements. The reflected radar signals are reflected from objects on or near the Earth's surface.

In one embodiment, the transmitter and receiver are time-multiplexed such that the transmitter is disconnected from the antenna during reception to minimize interference. For example, a processor of the system can connect the transmitter to its antenna, transmit a signal pulse toward the Earth and then disconnect its transmitter from the antenna and turn off its transmitter. The processor can then connect the receiver to the antenna and turn on its receiver to listen for a returning pulse (echo of the pulse) caused by the radar signal being reflected by an object or target in its path. When the reflected pulse (echo) signal can be received by the antenna, sampled by the onboard processor, and autocorrelated with the transmitted pulse signal (chirp) to provide radar pulse compression and improve the received signal-to-noise ratio. To explain further, in one embodiment, the onboard signal processing system may execute signal processing algorithms to: generate and shape the transmitted radar signal into a Linear Frequency Modulated (LFM) VHF/UHF carrier (or chirp); sample the reflected radar signal; perform autocorrelation between the transmitted radar signal and reflected radar signal to provide radar pulse compression and enhance signal-to-noise ratio (SNR), wherein the autocorrelation processing for pulse compression occurs in real-time; and digitally form and steer multiple narrow radar beams over a wide field of view.

According to other aspects of the present disclosure, the space-based radar system supports multi-beam operation thereby allowing the VLA phased array antenna to simultaneously form and steer multiple independent beams. For example, the satellite's onboard signal processor can be used to create multiple narrow beams that can be steered (moved or scanned) over a wide angle of view. Thus, a wide area can be illuminated by the radar simultaneously by the multiple beams and then sequentially as these multiple beams are moved from location to location within the satellite's field of view. In some embodiments, each independent beam may be assigned to a different communication channel, frequency band, or spatial region.

In one embodiment, the space-based radar system is configured to operate over a wideband frequency range, and dynamically adjust beamforming parameters to optimize performance across different frequencies. In one embodiment, the space-based radar system may further include a control system configured to optimize beamforming parameters based on algorithms or external command inputs. For example, the control system may be configured to receive external commands from a remote operator or an autonomous artificial intelligence (AI) module for real-time beam control and optimization.

According to other aspects of the present disclosure, the digital beamforming processor may be configured to execute beamforming algorithms on the radar signal from the transmitter and the reflected radar signals from the receiver to generate multiple narrow radar beams that are electronically steered to sequentially scan a wide area of the Earth's surface. In one embodiment, the beamforming processor is configured to implement distributed beamforming, wherein multiple independent systems coordinate transmission and reception to form a coherent array.

According to other aspects of the present disclosure, the beamforming processor is configured to dynamically adjust phase and amplitude weights of the antenna elements to optimize beam direction and shape. For example, the digital beamforming processor may be configured to apply digital phase and amplitude weighting to transmitted signals to form and steer one or more directional beams. As another example, the digital beamforming processor may be configured to apply digital filtering and signal correlation to received radar signals to enhance signal-to-noise ratio (SNR) and suppress interference. As another example, the digital beamforming processor may be configured to dynamically adjust beam parameters in response to changing signal conditions. For example, the beamforming processor may be configured for adaptive beamforming to continuously adjust beam parameters based on real-time environmental conditions or interference levels.

In one embodiment, the digital beamforming processor may be an agile digital beamforming processor. The agile digital beamforming processor processes signals in the digital domain has the ability to dynamically form and steer multiple independent beams in real time from a single antenna array using advanced signal processing techniques. For example, the agile digital beamforming processor may be configured to dynamically control the phase and amplitude of radar signals across the array of thin-film antenna elements to rapidly form, steer, and reconfigure directional beams in real time. The agile digital beamforming processor can make near-instantaneous changes to beam direction, allowing for real-time tracking of fast-moving objects, such as vehicles, aircraft, satellites, ground objects/targets or mobile users. This allow different signals need to be directed to different locations simultaneously. The agile digital beamforming processor can rapidly adjust beam direction to track moving objects or optimize signal quality. For example, in some cases, the agile digital beamforming processor can dynamically adjust beam patterns to minimize interference and maximize signal strength. It enables precise, adaptable control over signal directionality, making it highly valuable in applications such as satellite communications and radar.

In one embodiment, the beamforming processor utilizes minimum variance distortionless response (MVDR), least mean squares (LMS), or eigenvalue decomposition (EVD) algorithms for adaptive interference suppression.

In one embodiment, the beamforming processor implements spatial filtering to mitigate interference from undesired sources while enhancing signal reception from desired sources.

In accordance with the disclosed embodiments, larger apertures enable narrower beams, resulting in less radar clutter for easier target identification and require less power. The larger aperture of the VLA phased array antenna enables low UHF frequency operation of the VLA phased array antenna, which is beneficial for a number of reasons that will be discussed herein. For example, in one non-limiting embodiment, each VLA phased array antenna operates in an ultra-high frequency (UHF) band of radio frequencies that can range between 300 and 600 megahertz (MHz) for radar operation. For instance, each VLA phased array antenna can produce focused beams with 2° beamwidth at 350 MHz. In another non-limiting embodiment, each VLA phased array antenna can operate, for example, in a very-high frequency (VHF) band of radio frequencies that range between 30 and 300 megahertz (MHz). By operating at relatively low frequencies and hence relatively long wavelengths (with respect to those of conventional optical and higher-frequency radar systems), the disclosed radar systems can operate through any weather conditions and are not obstructed by clouds or storms for continuous custody. For instance, the VLA phased array antenna can transmit radar signals and receive reflected radar signal through obstacles such as clouds. Likewise, the disclosed space-based radar systems can penetrate dense foliage, buildings, and water to detect objects and targets that might otherwise be obscured from optical and higher-frequency radar systems.

In one embodiment, the space-based radar system is an Active Electronically Scanned Array (AESA)-based radar system that use many transmit/receive modules (TRMs) to independently control the phase and amplitude of radar beams, allowing for multiple, agile radar beams and enhanced capabilities like simultaneous air-to-air and air-to-ground tracking. AESA radar systems are considered an active phased array system, which includes an array of antennas which form a beam of radio waves that can be electronically aimed in different directions. AESA radar systems utilize a large number of TRMs, each connected to an antenna element, allowing for independent control of each beam's phase and amplitude. This independent control enables the generation of multiple, simultaneous radar beams, allowing for simultaneous tracking of multiple targets in different directions. AESA radar systems provide aircrews with a comprehensive view of the airspace, enabling them to track and engage targets more effectively. The also have ability to transmit energy at the target much faster (at the microsecond level), which allows for early track formation and accurate tracking of maneuvering targets. AESA radar systems can spread their signal emissions across a wider range of frequencies, making them more difficult to detect and jam. The AESA-based radar system may use numerous onboard signal processing gains including pulse compression, coherent integration, multi-pulse integration, and digital pulse-shaping to maintain a low per element power level.

In some embodiments, each of LEO satellites may include an optical intersatellite communication system that allows that LEO satellite to communicate with other LEO satellites in the constellation via intersatellite links. In other words, optical intersatellite links may allow the LEO satellites to communicate with other LEO satellites in the constellation. Each of LEO satellites may also be capable of directly communicating with ground stations.

In some embodiments, each of LEO satellites may further include a thin-film solar panel system. Power for all circuitry used on a LEO satellite can be generated by onboard thin film printed solar panels that are mounted on the back side of the satellite antenna's ground plane. In one implementation, the thin-film solar panel may be mounted, for example, opposite the array of thin-film antenna elements. For example, in one embodiment, unique thin-film solar panels have been demonstrated to achieve at least 16 times the power-to-weight (watts/kg) efficiency of conventional rigid silicon-based triple junction solar panels. This can provide a power source that is over 16× more efficient in terms of kW/kg than conventional silicon-based triple junction solar panels. This can allow the thin-film solar panel to generate electrical power (e.g., up to 15 kW) that power various subsystems of LEO satellite including the onboard signal processing system. The integration of these thin-film solar panels on the LEO satellite can enable low radar cross section, while also providing high onboard compute power for signal processing.

In one embodiment, the space-based radar system uses Doppler variation to remove clutter and detect objects.

In one embodiment, the space-based radar system includes multiple sensors, and raw data from multiple sensors at multiple angles can be combined for deeper analysis.

In one embodiment, the beamforming and signal processing algorithms are configurable via software updates to adapt to different radar scanning modes.

In one embodiment, the space-based radar system may have a mean time to detection of three (3) seconds or less, a minimum radar cross section of 10 cm², a beam azimuth to target of 45°, and a minimum detectable velocity (MDV) that is subsonic.

The three-second mean time to detection may be enabled by the fast beam hopping and millisecond-speed scanning capabilities of the digital beamformer, which can rapidly cycle through the field of regard. This agile scanning approach allows the system to survey large areas quickly while maintaining sufficient dwell time on each beam position for target detection.

The 10 cm² minimum radar cross section detection capability may be achieved through the combination of several system features. The very large aperture (VLA) phased array antenna provides high antenna gain, while pulse compression via autocorrelation processing enhances the signal-to-noise ratio. Additionally, coherent integration across multiple pulses and deep signal processing algorithms that leverage machine learning and artificial intelligence techniques may further improve the system's ability to detect small radar cross section objects.

The 45° beam azimuth to target capability may be enabled by the digital beamforming processor's ability to electronically steer beams by dynamically adjusting phase and amplitude weights across the array of thin-film antenna elements. This electronic beam steering allows the radar to direct beams at wide angles from boresight without mechanical movement of the antenna structure.

The subsonic minimum detectable velocity (MDV) may be achieved through Doppler processing and moving target indication (MTI) capabilities. The system uses Doppler variation to distinguish moving objects from stationary clutter, enabling detection and tracking of slow-moving targets such as ground vehicles, ships, and low-speed aircraft.

According to an aspect of the present disclosure, a low Earth orbit satellite is provided. The low Earth orbit satellite includes a deployable multilayer structural element movable from a folded or rolled launch configuration to a deployed configuration. The deployable multilayer structural element includes a carrier layer. The deployable multilayer structural element includes a plurality of electrodes formed on the carrier layer and arranged as an array of thin-film antenna elements. The deployable multilayer structural element includes a support substrate disposed opposite the carrier layer and separated from the plurality of electrodes by a separation distance, the support substrate providing a ground plane for the array of thin-film antenna elements. The deployable multilayer structural element includes a thin-film solar panel system supported by the support substrate. The low Earth orbit satellite includes a deployable support structure comprising carbon fiber booms configured to uncurl from a compact launch configuration and hold the deployable multilayer structural element in the deployed configuration. The low Earth orbit satellite includes, for each thin-film antenna element, a transmit path including a digital-to-analog converter and a power amplifier and a receive path including a low-noise amplifier and an analog-to-digital converter. The low Earth orbit satellite includes an onboard signal processing system coupled to the array of thin-film antenna elements through respective high-speed data links. The low Earth orbit satellite includes a digital beamforming processor configured to generate a linear frequency modulated radar signal in a VHF or UHF band. The digital beamforming processor is configured to time-multiplex transmission and reception by disconnecting the transmit path from a selected thin-film antenna element during reception. The digital beamforming processor is configured to autocorrelate a reflected radar signal with the linear frequency modulated radar signal in real time to perform pulse compression. The digital beamforming processor is configured to digitally form and steer multiple narrow radar beams over a field of view using the array of thin-film antenna elements.

According to other aspects of the present disclosure, the low Earth orbit satellite may include one or more of the following features. The respective high-speed data links may comprise fiber optic links. The plurality of electrodes may be printed on the carrier layer using a conductive ink. Each of the plurality of electrodes may be a conductive spiral. The support substrate may comprise a supporting layer and a thin conductive layer overlying a surface of the supporting layer, the thin conductive layer serving as the ground plane. The thin conductive layer may be a metalized layer and the supporting layer and the carrier layer may each comprise one or more of polyethylene terephthalate film, nylon film, mylar film, polyamide film, and polyimide film. The array of thin-film antenna elements may include at least 1000 elements distributed over a deployed area of at least 420 m². The digital beamforming processor may be reconfigurable via software updates to adapt to different radar scanning modes.

According to another aspect of the present disclosure, a space-based radar system is provided. The space-based radar system includes a constellation of low Earth orbit (LEO) satellites comprising a first LEO satellite and a second LEO satellite. Each LEO satellite includes a very large aperture phased array antenna comprising a ground plane and an array of thin-film antenna elements mounted on a carrier layer, a thin-film solar panel system mounted opposite the array of thin-film antenna elements, and a digital beamforming processor coupled to the thin-film antenna elements. Each LEO satellite includes an optical intersatellite communication system that communicates with other optical intersatellite communication systems on other LEO satellites. At least the first LEO satellite and the second LEO satellite are configured to steer multiple radar beams toward a common geographic region. At least the first LEO satellite and the second LEO satellite are configured to receive reflected radar signals from one or more objects within the common geographic region at different look angles. At least the first LEO satellite and the second LEO satellite are configured to exchange radar data through respective optical intersatellite communication systems. At least the first LEO satellite and the second LEO satellite are configured to combine the radar data received from the different look angles to detect or track the one or more objects.

According to other aspects of the present disclosure, the space-based radar system may include one or more of the following features. The first LEO satellite and the second LEO satellite may combine raw data from multiple sensors at multiple angles for target analysis. The LEO satellites may be capable of direct communication with one or more ground stations. The space-based radar system may further comprise a control system configured to receive external commands from a remote operator or an autonomous artificial intelligence module for real-time beam control and optimization. The control system may be configured to task additional LEO satellites in the constellation to the common geographic region so that the common geographic region is observed from multiple angles to reduce terrain masking. The space-based radar system may use a Doppler variation to remove clutter and detect objects. Multiple independent beams may be formed simultaneously and may be assigned to different communication channels, frequency bands, or spatial regions.

According to another aspect of the present disclosure, a method of operating a space-based radar system having a constellation of low Earth orbit satellites is provided. The method includes tasking a subset of the satellites to a geographic region of concern. The method includes, at each satellite in the subset, generating and transmitting a linear frequency modulated VHF or UHF radar signal using an array of thin-film antenna elements of a very large aperture phased array antenna toward the geographic region of concern. The method includes time-multiplexing transmission and reception by disconnecting a transmitter from at least one of the thin-film antenna elements during reception. The method includes digitizing received echoes using low-noise amplifiers and analog-to-digital converters associated with respective thin-film antenna elements. The method includes performing real-time autocorrelation between the transmitted radar signal and the received echoes to perform pulse compression. The method includes digitally forming and steering multiple narrow beams over a field of view. The method includes communicating radar data between at least two of the satellites through optical intersatellite links. The method includes combining radar data received at multiple angles to detect or track an object in the geographic region of concern.

According to other aspects of the present disclosure, the method may include one or more of the following features. The method may further comprise dynamically adjusting phase and amplitude weights of the thin-film antenna elements based on changing signal conditions. The method may further comprise fast beam hopping to cycle through a field of regard for object detection. The transmitted radar signal may be generated over a wideband frequency range and beamforming parameters may be dynamically adjusted across different frequencies. The method may further comprise communicating tasking information or processed radar data from one or more of the satellites to a ground station.

Further aspects, features, applications and advantages of the disclosed technology, as well as the structure and operation of various examples, are described in detail below with reference to the accompanying drawings. It is noted that the disclosed technology is not limited to the specific examples described herein. Such examples are presented herein for illustrative purposes only. Additional examples will be apparent to persons skilled in the relevant art(s) based on the teachings contained herein.

### BRIEF DESCRIPTION OF THE SEVERAL VIEWS OF THE DRAWINGS

For a better understanding of the present disclosure, non-limiting and non-exhaustive examples of the present disclosure are described with reference to the following drawings, in which:

FIG. 1A is a diagram of a satellite system or constellation of satellites in respective orbits around the Earth in which the aspects of the technology may be employed;

FIG. 1B is a simplified diagram illustrating a system environment for communication using satellites and inter satellite communication in which aspects of the technology may be employed;

FIG. 1C is a simplified diagram illustrating a radar system implemented by utilizing the constellation of satellites for detection of objects in which aspects of the technology may be employed;

FIG. 1D is a block diagram of an exemplary radar system in which aspects of the technology may be employed;

FIG. 1E is a block diagram of an exemplary phased array antenna system in which aspects of the technology may be employed;

FIG. 2A is a diagram illustrating an architecture for beamforming according to aspects of disclosed technology;

FIG. 2B is a block diagram illustrating a beamforming architecture according to aspects of disclosed technology;

FIGS. 3A and 3B are diagrams illustrating top and front views of one non-limiting example of satellite in which aspects of the technology may be practiced;

FIG. 4 is a block diagram of the satellite of the system environment according to aspects of the disclosed technology;

FIG. 5 is a block diagram that illustrates an optical inter-satellite link (OISL) system associated with the first satellite and the second satellite according to aspects of the disclosed technology; and

FIG. 6 is a diagram illustrating one example of computing device in which aspects of the technology may be practiced.

In the drawings, similar reference numerals refer to similar parts throughout the drawings unless otherwise specified. These drawings are not necessarily drawn to scale.

### DETAILED DESCRIPTION

Technologies are provided for radar systems, and more particularly, provided for space-based phase array antenna. The specification and accompanying drawings disclose one or more exemplary embodiments that incorporate the features of the present disclosure. The scope of the present disclosure is not limited to the disclosed embodiments. The disclosed embodiments merely exemplify the present disclosure, and modified versions of the disclosed embodiments are also encompassed by the present disclosure. Embodiments of the present disclosure are defined by the claims appended hereto.

It is noted that any section/subsection headings provided herein are not intended to be limiting. Any embodiments described throughout this specification, and disclosed in any section/subsection may be combined with any other embodiments described in the same section/subsection and/or a different section/subsection in any manner.

Implementations of the techniques described herein may include hardware, a method or process, or a non-transitory computer readable medium, etc. Other embodiments of this aspect include corresponding computer systems, apparatus, and computer programs recorded on one or more computer storage devices, each configured to perform the actions of the methods. The system may include one or more computers that can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. Implementations may include one or more of the following features. Prior to describing exemplary embodiments that incorporate the features of the present disclosure, a discussion of security concepts that are appliable to the exemplary embodiments will be provided.

A space-based radar system is provided that includes a constellation of low Earth orbit (LEO) satellites forming a distributed radar network that provides seamless global radar coverage. Each LEO satellite includes a phased array antenna system that enables electronic beam steering without mechanical movement. For instance, the LEO satellites may be equipped with an active electronically scanned array (AESA) for synthetic aperture radar (SAR) and other radar imaging applications. Closer proximity of LEO satellites to Earth enables higher resolution for SAR imaging, independent of weather or lighting conditions. Each LEO satellite is capable of digital beamforming (DBF).

The LEO satellites leverage advanced digital beamforming (DBF) technologies to dynamically steer and shape beams in real time, improving resolution, coverage, and adaptability. DBF allows for multiple simultaneous beams, adaptive nulling and beam shaping, interference mitigation, multi-target tracking, and super-resolution imaging via advanced signal processing techniques. As such, the constellation of LEO satellites can lock multi-beam phased-array radars onto targets from multiple satellites, which allows the system to paint a target from multiple directions with long-wavelength radar from multiple satellites at the same time. Moving target indication (MTI) capabilities allow for tracking moving objects like vehicles, ships, aircraft, missiles, etc. In one embodiment, the digital beamformer is configured to allow for fast beam hopping to cycle through a field of regard to detect the objects/targets on or near the Earth's surface. For example, the millisecond speed scanning and beam hopping capabilities of the digital beamformer can cycle through the field of regard to detect objects/targets within seconds anywhere on earth. This can enable continuous scanning of the entire Earth for the earliest possible target detection.

Additionally, the disclosed LEO satellites can operate in an ultra-high frequency (UHF) band of radio frequencies (e.g., between 300 and 600 megahertz (MHz). As such, by operating at relatively low frequencies and relatively long wavelengths (with respect to those of conventional radar systems), the disclosed radar systems can operate through any weather conditions and are not obstructed by clouds or storms. Likewise, the disclosed radar systems can penetrate dense foliage, buildings, and water to detect objects and targets that might otherwise be obscured from optical and higher-frequency radar systems.

In some implementations, the LEO satellites may communicate with each other and ground stations using inter-satellite links (ISLs). The capability of the LEO satellites to communicate with other LEO satellites via optical intersatellite links, and/or to communicate directly with ground stations or aircraft allow for immediate communications across global or local architectures. For instance, the capability of the LEO satellites to communicate with other LEO satellites via optical intersatellite links not only allows for satellite-to-satellite handovers, but can also allow the satellites to share data with each other in real-time or near-real-time. As such, satellites can process data from other satellites and fuse it to improve coverage and target tracking. For example, satellites in the constellation can exchange data via optical or RF inter-satellite links (ISL) to synchronize observations and enhance real-time processing. This enables applications such as change detection, moving target indication (MTI), etc. In some embodiments, the satellites can implement onboard AI for live classification and flight tracking alone or in conjunction with other satellites. Multi-satellite, multi-angle tracking enables a coordinated classification between the satellites, using inter-satellite optical links, to provide the greater likelihood of target detection even for stealth objects with radar cross sections down to 0.1 m². Additionally, direct data links from the LEO satellites to ground terminals enable real-time communication and tasking. Tasking can direct the space-based radar system to focus more LEO satellites in geographic regions of concern so that even more LEO satellites provide coverage to a specific geographic region. This can, for example, help ensure that targets or objects of concern cannot hide behind terrain. Alternatively, this capability could be used to scan borders or geo-fenced keep out areas for intrusion.

Another advantage of the disclosed space-based radar system is that because multiple LEO satellites are always in view that implement adaptive nulling and fast scanning beams, ground-based to jam the disclosed space-based radar system are ineffective. Additionally, in some implementation, the disclosed space-based radar system can be further tasked to locate, disrupt, degrade, and overwhelm ground-based radars across multiple frequencies of interest.

The constellation cooperates to provide wide-area global radar coverage that allows for high-resolution Earth observation, remote sensing, persistent target detection and monitoring capabilities, and space situational awareness.

### Example Applications of the Disclosed Technology

Example applications of the disclosed global radar technology can include, but are not limited to, advanced target custody, warning, tracking, and defeat systems. In one embodiment, the space-based radar system can be used to implement an Orbital Phased Array Warning System (PAWS) that is capable of revolutionizing missile detection and defense systems. For example, the space-based radar system can be used detect and track hypersonic and sub-sonic targets, such as, vehicles, aircraft, ballistic missiles, satellites, and even smaller objects—anywhere, in any weather, continuously in real-time. VLA arrays combined with agile digital beamforming and deep signal processing, considerably enhances target resolution for both hypersonic and subsonic targets while reducing radar clutter.

To modernize the world's air traffic management systems, yet another possible commercial application of the disclosed space-based radar system is in providing high-quality continuous radar coverage to aircraft. This can help eliminate surveillance gap areas where there is no radar coverage and increase safety. For example, the disclosed space-based radar system can provide continuous onboard AI-based classification, tracking, alerts/warnings, etc. to allow for direct routing of aircraft thereby reducing travel time and saving fuel. In one implementation, the disclosed space-based radar system can provide real time global capabilities for space-based Automatic Dependent Surveillance-Broadcast (ADS-B) and Automatic Dependent Surveillance-Contract (ADS-C) to track aircraft with matching against radar signatures using onboard AI to classify these objects.

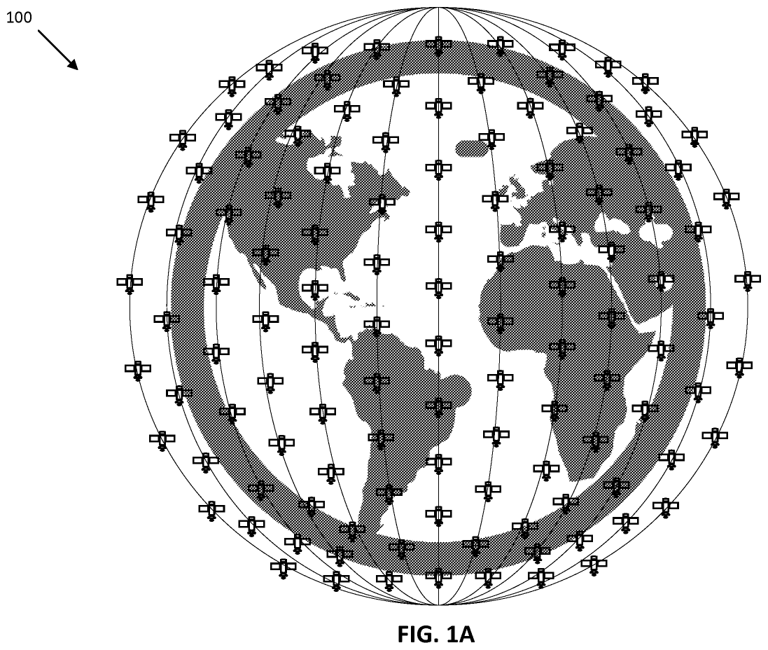

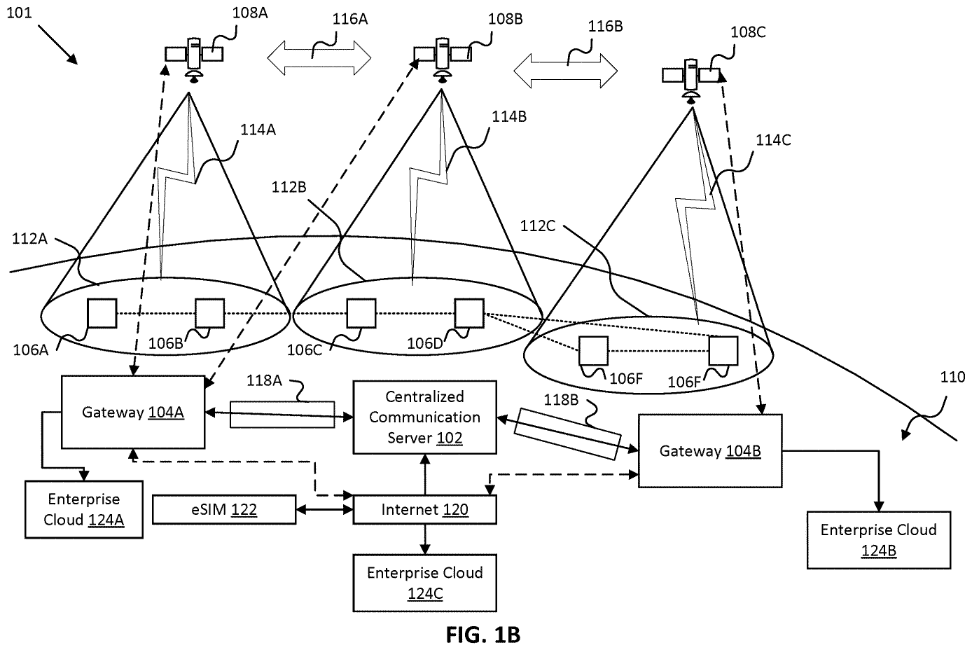

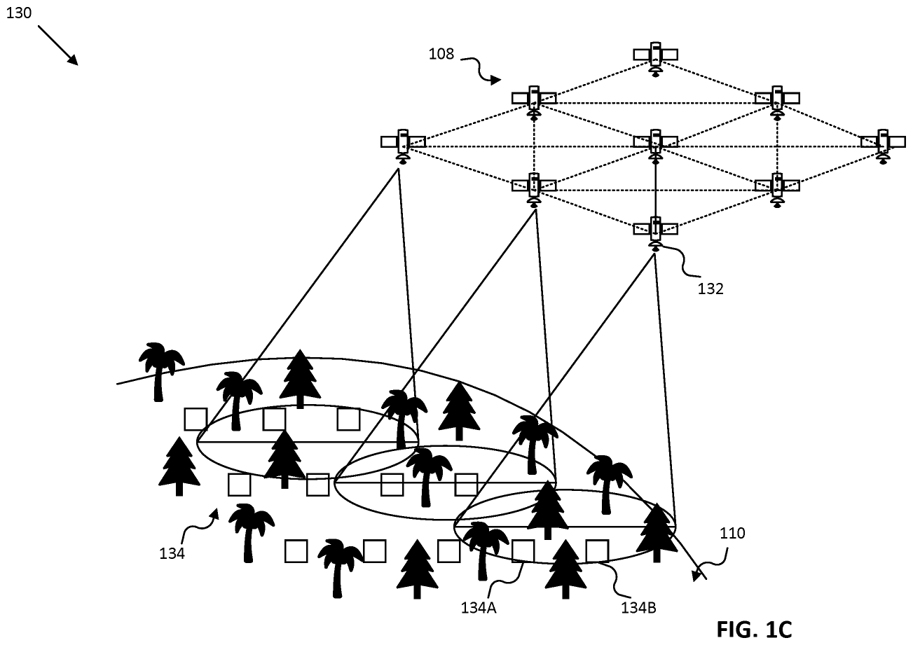

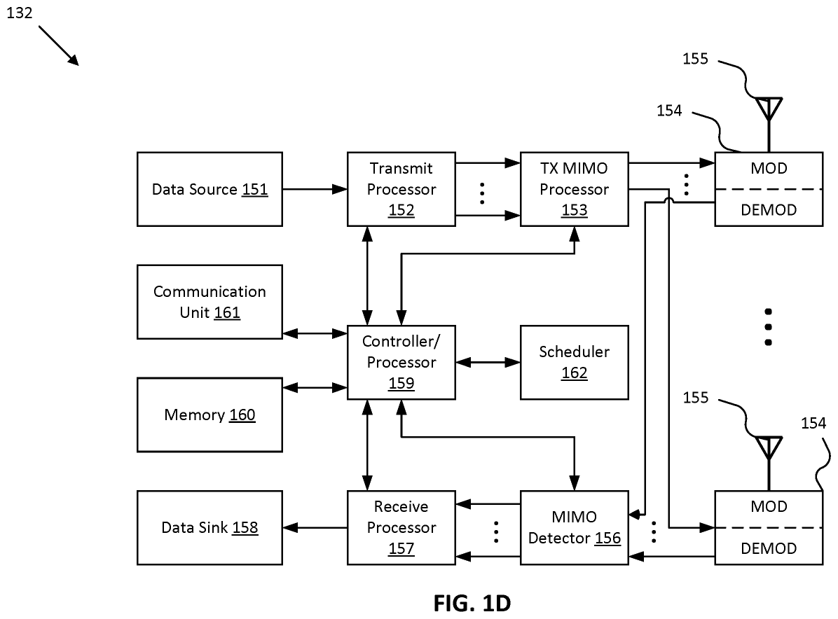

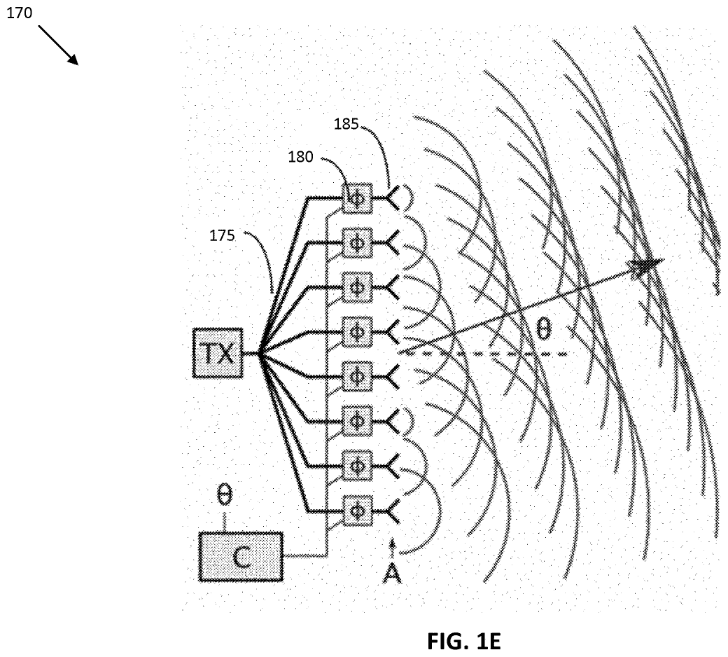

Having given this description of space-based phased array radar, technologies will now be described with reference to FIGS. 1-7 for detection of targeted objects using space-based phased array radar.

FIG. 1A is a diagram of a constellation 100 of satellites in respective orbits around the Earth in which the aspects of the technology may be employed. The constellation 100 may include a group of artificial satellites that are positioned in number of different orbits around the Earth to provide specific services or coverage. For instance, the satellites may work together to offer communication, navigation, or remote sensing services to a wide geographic area on Earth. The constellation 100 may include any number of satellites required to ensure global coverage and to provide redundancy in case of failure. It should be appreciated that such satellite constellations can be arranged in different configurations, including low Earth orbit (LEO), medium Earth orbit (MEO), or geostationary orbit (GEO), depending on the intended application and the desired level of coverage and service. In one embodiment, a space-based radar system is provided that includes the constellation 100 of LEO satellites forming a distributed radar network that provides seamless global radar coverage. Each LEO satellite includes a phased array antenna system that enables electronic beam steering without mechanical movement. For instance, the LEO satellites may be equipped with an active electronically scanned array (AESA) for synthetic aperture radar (SAR) and other radar imaging applications. Closer proximity of LEO satellites to Earth enables higher resolution for SAR imaging, independent of weather or lighting conditions. Each LEO satellite is capable of digital beamforming (DBF).

For example, in one non-limiting implementation, the space-based radar system may include approximately 390 satellites or more in LEO (e.g., at or around 720 kilometers from the Earth's surface). As will be described below, this can provide multiple satellite coverage at any point on or near the Earth to enable a distributed array radar that can provide global coverage.

FIG. 1B is a simplified diagram illustrating a system environment 101 for communication using satellites and inter satellite communication in which aspects of the technology may be employed. The system environment 101 includes a centralized communication server 102, multiple gateways 104, multiple user equipment (UE) 106 that are in communication with each other, a constellation of satellites 108 that are in communication with one or more of the UE 106. The constellation of satellites 108 includes a group of artificial satellites that are positioned in a number of different orbits around the Earth 110 to provide specific services or coverage. For instance, the satellites 108 may work together to offer communication, navigation, or remote sensing services to a wide geographic area on Earth. The constellation of satellites 108 may include any number of satellites to ensure global coverage and to provide redundancy in case of failure. In one embodiment, the satellites 108 may make up a 5G Non-Terrestrial Network, such as a Low Earth Orbit (LEO) constellation, and each satellite 108 is configured to implement a network (e.g., a 5G core network) and a base station that act or serve as a network node of the non-terrestrial network. The base station communicates with at least one UE of the plurality of UE 106. The gateways 104 may make up a communicative network and each satellite may be communicatively coupled to at least one of the gateways 104. In some cases, the system environment 101 may support enhanced broadband communications, ultra-reliable (e.g., mission critical) communications, low latency communications, or communications with low-cost and low-complexity devices. It should be appreciated that such satellite constellations can be arranged in different configurations, including low Earth orbit (LEO), medium Earth orbit (MEO), or geostationary orbit (GEO), depending on the intended application and the desired level of coverage and service.

Each of the satellites 108 is an artificial object placed in orbit around a celestial body, often referring to Earth 110. Each satellite typically includes various components such as a communication or scientific payload, power systems (such as solar panels), propulsion for orbit adjustments, and communication equipment to transmit and receive data to and from Earth 110. Each satellite, e.g., the satellite 108A, may include a 5G core network and a base station that may wirelessly communicate with UEs 106 via one or more antennas and provide 5G communication network services to the UEs 106 directly. The 5G core network of the satellites 108 may be referred to as a central component of a 5G network that may establish reliable, secure connectivity for end users and provides access to services. The 5G core network may be configured to perform functions including connectivity management, authentication, subscriber data management, and policy management. The base stations of the satellites 108 may be referred to by those skilled in the art as a base transceiver station, a radio base station, an access point, a radio transceiver, a NodeB, an eNodeB (eNB), a next-generation Node B or giga-nodeB (either of which may be referred to as a gNB), a Home NodeB, a Home eNodeB, or some other suitable terminology. The base stations of the satellites 108 may be of different types (e.g., macro or small cell base stations). The UEs 106 described herein may be able to communicate with various types of base stations and network equipment including macro eNBs, small cell eNBs, gNBs, relay base stations, and the like.

Each satellite, for example satellite 108A, may be associated with a particular geographic coverage area, for example, geographic coverage area 112A in which communications with various UEs, such as the UEs 106A and 106B is supported. For sake of simplicity, FIG. 1 shows a simplified representation that includes three geographic coverage areas 112, which may be referred to herein as a first geographic coverage area 112A, a second geographic coverage area 112B, and a third geographic coverage area 112C; however, it should be appreciated that each satellite 108 includes an associated geographic coverage area. Each satellite may provide communication coverage for a respective geographic coverage area via communication links 114, and communication links 114 between a base station of satellite 108 and a UE 106 may utilize one or more carriers. The communication links 114 may include upstream transmissions from the UE 106 to the base station of satellite 108, or downstream transmissions from the base station of satellite 108 to the UE 106. Downstream transmissions may also be called downlink or forward link transmissions while upstream transmissions may also be called uplink or reverse link transmissions.

Although not shown in FIG. 1, each geographic coverage area 112 of a satellite 108 may be divided into sectors (not shown) each making up a portion of the geographic coverage area 112, and each sector may be associated with a cell. For example, each satellite may provide communication coverage for a macro cell, a small cell, a hot spot, or other types of cells, or various combinations thereof. In some examples, the satellites may be non-stationary and therefore provide communication coverage for a moving geographic coverage area 112. In some examples, different geographic coverage areas 112 associated with different technologies may overlap, and the overlapping geographic coverage areas 112 associated with different technologies may be supported by the same satellite or by different satellites. The system environment 101 may include, for example, a heterogeneous 5G network in which different types of satellites provide coverage for various geographic coverage areas 112.

The term “cell” refers to a logical communication entity used for communication with a base station (e.g., over a carrier) or a satellite beam, and may be associated with an identifier for distinguishing neighboring cells (e.g., a physical cell identifier (PCID), a virtual cell identifier (VCID)) operating via the same or a different carrier. In some examples, a carrier may support multiple cells, and different cells may be configured according to different protocol types (e.g., machine-type communication (MTC), narrowband Internet-of-Things (NB-IoT), enhanced mobile broadband (eMBB), or others) that may provide access for different types of devices. In some cases, the term “cell” may refer to a portion of a geographic coverage area 112 (e.g., a sector) over which the logical entity operates.

Each satellite, for example satellite 108A, may be communicatively coupled with other satellites, for example satellite 108B, via intersatellite links 116, for example intersatellite link 116A, which allow satellites 108 in a constellation to link to one another and relay data in space. For sake of simplicity, FIG. 1 shows a simplified representation that includes two intersatellite links, which may be referred to herein as a first intersatellite link 116A and a second intersatellite link 116B; however, it should be appreciated that any two satellites may be communicatively coupled via an associated intersatellite link. Each satellite may provide or receive data to or from other satellites via inter satellite links 116.

Each of the gateways 104 on Earth 110 may wirelessly communicate with satellites 108 via one or more antennas (not shown). The gateways 104 may be configured to route and forward the data associated with the 5G communications between the 5G core network of the satellites 108 and the centralized communication server 102 to facilitate the 5G communications between the 5G base station with the at least one UE 106. In one embodiment, each gateway 104 may be communicatively coupled to the centralized communication server 102 by way of a transport medium 118 to route the data to and from the satellites 108. For example, the gateways 104A and 104B may be communicatively coupled to the centralized communication server 102 by way of the transport mediums 118A and 118B, respectively. Further, each gateway may be coupled to one or more gateways and may be configured to route data to or from the centralized communication server 102 directly or by way of one or more gateways between the respective gateway and the centralized communication server 102.

Each gateway 104, such as the gateway 104A, may be communicatively coupled to one or more of the satellites 108 when the one or more of the satellites 108 are within the communication range of the respective gateway 104. For sake of simplicity, FIG. 1 shows a simplified representation that includes two gateways 104, which may be referred to herein as a first gateway 104A and a second gateways 104B; such that the first gateway 104A is communicatively coupled to the first and second satellites 108A and 108B and the second gateway 104B is communicatively coupled to the third satellite 108C.

The UEs 106 may be deployed at different locations in a geographic coverage area 112 that includes, for example, a forest, an agricultural land, or the like. In one embodiment, for example, the UEs 106 are positioned at the different locations in certain geographic area to provide sensor coverage over part of or substantially all of the area. The UEs 106 may also be referred to as a mobile device, a wireless device, a remote device, a handheld device, or a subscriber device, or some other suitable terminology, where the “device” may also be referred to as a unit, a station, a terminal, or a client. The UE 106 may also be a personal electronic device such as a cellular phone, a personal digital assistant (PDA), a tablet computer, a laptop computer, or a personal computer. In some examples, the UE 106 may also refer to a wireless local loop (WLL) station, an Internet of Things (IoT) device, an Internet of Everything (IoE) device, or an MTC device, or the like, which may be implemented in various articles such as appliances, vehicles, meters, or the like.

In an embodiment, some or all of the UEs 106 may be implemented as MTC or IoT devices, which may be low cost or low complexity devices, and may provide for automated communication between machines (e.g., via Machine-to-Machine (M2M) communication). M2M communication or MTC may refer to data communication technologies that allow devices to communicate with one another or a base station of a satellite without human intervention. In some examples, M2M communication or MTC may include communications from devices that integrate sensors or meters to measure or capture information and relay that information to a central server or application program that can make use of the information or present the information to humans interacting with the program or application. The UEs 106 may be designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The UEs 106 may be configured to employ operating modes that reduce power consumption, such as half-duplex communications (e.g., a mode that supports one-way communication via transmission or reception, but not transmission and reception simultaneously). In some examples half-duplex communications may be performed at a reduced peak rate. Other power conservation techniques for the UEs 106 include entering a power saving “deep sleep” mode when not engaging in active communications, or operating over a limited bandwidth (e.g., according to narrowband communications). In some cases, the UEs 106 may be designed to support critical functions (e.g., mission critical functions), and the system environment 101 may be configured to provide ultra-reliable communications for these functions.

In some embodiments, a UE, such as the UE 106A may also be able to communicate directly with other UEs, such as the UE 106B (e.g., using a peer-to-peer (P2P) or device-to-device (D2D) protocol). One or more of a group of UEs 106 utilizing D2D communications may be within the geographic coverage area 112 of a satellite, such as the geographic coverage area 112A of the satellite 108A. Other UEs 106 in such a group may be outside the geographic coverage area 112A of the satellite 108A or be otherwise unable to receive transmissions from the satellite 108A. In some cases, groups of UEs 106 communicating via D2D communications may utilize a one-to-many (1:M) system in which each UE 106 transmits to every other UE 106 in the group. In some cases, a base station facilitates the scheduling of resources for D2D communications. In other cases, D2D communications are carried out between UEs 106 without the involvement of a base station.

In some embodiments, the UEs 106 and the satellites 108 that make up the constellation are designed so that they are capable of non-line-of-sight (NLOS) communications with one another. When communication devices, such as the UEs 106 and based stations implemented at satellites 108, are capable of NLOS communication, the device can establish communication links 114 even when there are obstacles or obstructions between the transmitter and the receiver. In traditional line-of-sight communication, a clear and unobstructed path is needed between the transmitting and receiving antennas for reliable signal transmission. By contrast, NLOS communication allows signals to propagate and reach the receiver even if there are buildings, trees, terrain features, or other obstacles in the way. NLOS communication is particularly useful, for example, in urban environments, dense foliage, indoor settings, and situations where direct line-of-sight paths are blocked.

The system environment 101 may operate using one or more frequency bands, typically in the range of 300 MHz to 300 GHz. Generally, the region from 300 MHz to 3 GHz is known as the ultra-high frequency (UHF) region or decimeter band, since the wavelengths range from approximately one decimeter to one meter in length. UHF waves may be blocked or redirected by buildings and environmental features. However, the waves may penetrate structures sufficiently for a macro cell to provide service to UEs 106 located indoors or under some obstruction or blockage. Transmission of UHF waves may be associated with smaller antennas and shorter range (e.g., less than 100 km) compared to transmission using the smaller frequencies and longer waves of the high frequency (HF) or very high frequency (VHF) portion of the spectrum below 300 MHz.

The system environment 101 may further operate in a super high frequency (SHF) region using frequency bands from 3 GHz to 30 GHz, also known as the centimeter band. The SHF region includes bands such as the 5 GHz industrial, scientific, and medical (ISM) bands, which may be used opportunistically by devices that can tolerate interference from other users.

The system environment 101 may further operate in an extremely high frequency (EHF) region of the spectrum (e.g., from 30 GHz to 300 GHz), also known as the millimeter band. In some examples, the system environment 101 may support millimeter wave (mmW) communications between UEs 106 and base stations of satellites 108, and EHF antennas of the respective devices may be even smaller and more closely spaced than UHF antennas. In some cases, this may facilitate use of antenna arrays within a UE 106. However, the propagation of EHF transmissions may be subject to even greater atmospheric attenuation and shorter range than SHF or UHF transmissions. Techniques disclosed may be employed across transmissions that use one or more different frequency regions, and designated use of bands across these frequency regions may differ by country or regulating body.

In some cases, the system environment 101 may utilize both licensed and unlicensed radio frequency spectrum bands. For example, the system environment 101 may employ License Assisted Access (LAA), LTE-Unlicensed (LTE-U) radio access technology, or NR technology in an unlicensed band such as the 5 GHz ISM band. When operating in unlicensed radio frequency spectrum bands, wireless devices such as base stations of satellites 108 and UEs 106 may employ listen-before-talk (LBT) procedures to ensure a frequency channel is clear before transmitting data. In some cases, operations in unlicensed bands may be based on a CA configuration in conjunction with CCs operating in a licensed band (e.g., LAA). Operations in unlicensed spectrum may include downstream transmissions, upstream transmissions, peer-to-peer transmissions, or a combination of these. Duplexing in unlicensed spectrum may be based on frequency division duplexing (FDD), time division duplexing (TDD), or a combination of both.

In some examples, the satellites 108 and/or UEs 106 may be equipped with multiple antennas, which may be used to employ techniques such as transmit diversity, receive diversity, multiple-input multiple-output (MIMO) communications, or beamforming. For example, the system environment 101 may utilize a transmission scheme between a transmitting device (e.g., a satellite 108 or a UE 106) and a receiving device (e.g., a UE 106 or a satellite 108), where the transmitting device is equipped with multiple antennas and the receiving devices are equipped with one or more antennas. MIMO communications may employ multipath signal propagation to increase the spectral efficiency by transmitting or receiving multiple signals via different spatial layers, which may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams. Different spatial layers may be associated with different antenna ports used for channel measurement and reporting. MIMO techniques include single-user MIMO (SU-MIMO) where multiple spatial layers are transmitted to the same receiving device, and multiple-user MIMO (MU-MIMO) where multiple spatial layers are transmitted to multiple devices.

The system environment 101 may further include Internet 120, embedded subscriber identity module (eSIM) 122, and multiple enterprise clouds 124. The Internet 120 may be coupled with the gateways 104 and the centralized communication server 102. In one embodiment, the gateways 104 may be configured to write the data which is received by the gateways 104 from the satellites 108 directly over the Internet 120 or directly over the enterprise clouds 124A and 124B for collection and processing of data by associated enterprises or organizations. For example, the gateway 104A may be configured to directly send the data received from the satellites 108A and 108B to the enterprise cloud 124A and the gateway 104B may be configured to directly send the data received from the satellite 108C to the enterprise cloud 124B. In another embodiment, the gateways 104 may be configured to write the data which is received by the gateways 104 from the satellites 108 over the enterprise cloud 124C via the Internet 120 for collection and processing of data by associated enterprises or organizations. For example, the gateways 104A and 104B may be configured to send the data received from the satellites 108A-108C to the enterprise cloud 124C via the Internet 120. In one embodiment, the enterprise clouds 124A-124C may employ at least one of access stratum (AS) and application function (AF) features associated with the 5G communication network.

In one embodiment, at least one of the centralized communication server 102 and the gateways 104 may be communicatively coupled to the eSIM 122 by way of the Internet 120. The eSIM 122 may be a programmable SIM card that may be remotely provisioned. The eSIM 122 may employ subscription management data preparation (SM-DP) and subscription management secure routing (SM-SR) functions associated with the 5G communication network. The SM-DP function may be configured to prepare and store M2M eSIM profiles and the SM-SR function may be configured to establish a secure channel and interact with an embedded universal integrated circuit card (eUICC).

FIG. 1C is a simplified diagram illustrating a radar system 130 implemented by utilizing the constellation of satellites 100 for detection of objects 134 in which aspects of the technology may be employed. The radar system 130 includes a multiple objects 134, the constellation of satellites 100 that may detect one or more of the objects 134. The constellation of satellites 100 includes a group of artificial satellites that are positioned in a number of different orbits around the Earth 110 to provide specific services or coverage.

In one embodiment, the constellation of satellites 100 corresponds to the LEO satellites. The LEO satellites leverage advanced DBF technologies to dynamically steer and shape beams in real time, improving resolution, coverage, and adaptability. DBF allows for multiple simultaneous beams, adaptive nulling and beam shaping, interference mitigation, multi-target tracking, and super-resolution imaging via advanced signal processing techniques. As such, the constellation of LEO satellites can lock multi-beam phased-array radars onto targets from multiple satellites, which allows the system to paint a target from multiple directions with long-wavelength radar from multiple satellites at the same time. Moving target indication (MTI) capabilities allow for tracking moving objects 134 like vehicles, ships, aircraft, missiles, etc. In one embodiment, the digital beamformer is configured to allow for fast beam hopping to cycle through a field of regard to detect the objects/targets 134 on or near the Earth's surface. For example, the millisecond speed scanning and beam hopping capabilities of the digital beamformer can cycle through the field of regard to detect objects/targets within seconds anywhere on earth. This can enable continuous scanning of the entire Earth for the earliest possible target detection.

Additionally, the disclosed LEO satellites can operate in an ultra-high frequency (UHF) band of radio frequencies (e.g., between 300 and 600 megahertz (MHz). As such, by operating at relatively low frequencies and relatively long wavelengths (with respect to those of conventional radar systems), the disclosed radar systems can operate through any weather conditions and are not obstructed by clouds or storms. Likewise, the disclosed radar systems can penetrate dense foliage, buildings, and water to detect objects and targets that might otherwise be obscured from optical and higher-frequency radar systems.

In some implementations, the LEO satellites may communicate with each other and ground stations using inter-satellite links (ISLs) 116. The capability of the LEO satellites to communicate with other LEO satellites via optical intersatellite links, and/or to communicate directly with ground stations (such as gateways 104 and the central communication server 102) or aircraft allow for immediate communications across global or local architectures. For instance, the capability of the LEO satellites to communicate with other LEO satellites via optical intersatellite links not only allows for satellite-to-satellite handovers, but can also allow the satellites to share data with each other in real-time or near-real-time. As such, satellites can process data from other satellites and fuse it to improve coverage and target tracking. For example, satellites in the constellation can exchange data via optical or RF inter-satellite links (ISL) to synchronize observations and enhance real-time processing. This enables applications such as change detection, moving target indication (MTI), etc. In some embodiments, the satellites can implement onboard AI for live classification and flight tracking alone or in conjunction with other satellites. Multi-satellite, multi-angle tracking enables a coordinated classification between the satellites, using inter-satellite optical links, to provide a greater likelihood of target detection even for stealth objects with radar cross sections down to 0.1 m2. Additionally, direct data links from the LEO satellites to ground terminals enable real-time communication and tasking. Tasking can direct the space-based radar system to focus more LEO satellites in geographic regions of concern so that even more LEO satellites provide coverage to a specific geographic region. This can, for example, help ensure that targets or objects of concern cannot hide behind terrain. Alternatively, this capability could be used to scan borders or geo-fenced keep out areas for intrusion.

Another advantage of the disclosed space-based radar system is that because multiple LEO satellites are always in view that implement adaptive nulling and fast scanning beams, ground-based to jam the disclosed space-based radar system are ineffective. Additionally, in some implementation, the disclosed space-based radar system can be further tasked to locate, disrupt, degrade, and overwhelm ground-based radars across multiple frequencies of interest. The constellation 100 cooperates to provide wide-area global radar coverage that allows for high-resolution Earth observation, remote sensing, persistent target detection and monitoring capabilities, and space situational awareness.

### Example Applications of the Disclosed Technology

Example applications of the disclosed global radar technology can include, but are not limited to, advanced target custody, warning, tracking, and defeat systems. In one embodiment, the space-based radar system can be used to implement an Orbital Phased Array Warning System (PAWS) that is capable of revolutionizing missile detection and defense systems. For example, the space-based radar system can be used detect and track hypersonic and sub-sonic targets, such as, vehicles, aircraft, ballistic missiles, satellites, and even smaller objects—anywhere, in any weather, continuously in real-time. VLA arrays combined with agile digital beamforming and deep signal processing, dramatically enhances target resolution for both hypersonic and subsonic targets while reducing radar clutter.

To modernize the world's air traffic management systems, yet another possible commercial application of the disclosed space-based radar system is in providing high-quality continuous radar coverage to aircraft. This can help eliminate surveillance gap areas where there is no radar coverage and increase safety. For example, the disclosed space-based radar system can provide continuous onboard AI-based classification, tracking, alerts/warnings, etc. to allow for direct routing of aircraft thereby reducing travel time and saving fuel. In one implementation, the disclosed space-based radar system can provide real time global capabilities for space-based Automatic Dependent Surveillance-Broadcast (ADS-B) and Automatic Dependent Surveillance-Contract (ADS-C) to track aircraft with matching against radar signatures using onboard AI to classify these objects.

### Satellites

Each of the satellites 108 of the constellation 100 may be a communications satellite that includes at least one radar system 132. The radar system 132 on the satellite 108 is an operative component of the radar transmission systems, serving as an access point for two-way high frequency wave transmission transmitted from the satellite 108 and received by the satellite 108 after reflecting from the Earth 110 or any object/target 134 as well as between two or more of the satellites 108. The radar system 132 may be housed within (or as part of) the satellite's payload and may include transceivers and antennas designed to facilitate seamless communication across vast distances. The radar system 132 plays a role in obtaining, amplifying, and routing signals between the targets/objects 134 and the satellites, ensuring robust and efficient detection. The radar system 132 is often equipped with advanced signal processing capabilities, enabling functions like modulation, demodulation, encoding, and decoding to optimize the quality and reliability of communication links 115, and can be useful for various satellite-based services, including global broadband internet, broadcasting, navigation, and Earth observation. One non-limiting example of a base station will now be described with reference to FIG. 1B.

FIG. 1D is a block diagram of an exemplary radar system 132 in which aspects of the technology may be employed, where “exemplary” means one non-limiting example. In some embodiments, such as that illustrated, the radar system 132 may be equipped with multiple antennas 155.

At the radar system 132, a transmit processor 152 may receive data from a data source 151 for generation and transmission of high frequency waves for object/target detection. The transmit processor 152 may further process system information (e.g., for semi-static resource partitioning information (SRPI) and/or the like) and control information (e.g., CQI requests, grants, upper layer signaling, and/or the like) and provide overhead symbols and control symbols. The transmit processor 152 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 153 may perform spatial processing (e.g., precoding) on the data symbols, the control symbols, the overhead symbols, and/or the reference symbols, if applicable, and may provide T output symbol streams to T modulators (MODs) 154. Each modulator 154 may process a respective output symbol stream (e.g., for OFDM and/or the like) to obtain an output sample stream. Each modulator 154 may further process (e.g., convert to analog, amplify, filter, and upconvert) the output sample stream to obtain a downlink signal. T downlink signals from modulators 154 may be transmitted via the antennas 155. According to various aspects described in more detail below, the synchronization signals may be generated with location encoding to convey additional information.

The downlink signals from radar system 132 may be transmitted towards the targets/objects 134 and/or the transmitted signal may be provided to demodulators (DEMODs) 154. Each demodulator 154 may condition (e.g., filter, amplify, downconvert, and digitize) a received signal to obtain input samples. Each demodulator 154 may further process the input samples (e.g., for OFDM and/or the like) to obtain received symbols. A MIMO detector 156 may obtain received symbols from the demodulators 154, perform MIMO detection on the received symbols if applicable, and provide detected symbols. A receive processor 157 may process (e.g., demodulate and decode) the detected symbols, provide decoded data to a data sink 158, and provide decoded control information and system information to a controller/processor 159. A channel processor may determine reference signal received power (RSRP), received signal strength indicator (RSSI), reference signal received quality (RSRQ), channel quality indicator (CQI), and/or the like.

On the uplink, the signals reflected from the targets/objects 134 may be provided to the radar system 132. At the radar system 132, the uplink signals may be received by antennas 155, processed by demodulators 154, detected by a MIMO detector 156 if applicable, and further processed by a receive processor 157 to obtain decoded data and control information. The receive processor 157 may provide the decoded data to a data sink 158 and the decoded control information to the controller/processor 159. The radar system 132 may include a communication unit 161.

The controller/processor 159 of the radar system 132 and/or any other component(s) of FIG. 1D may perform one or more techniques associated with detection of targets/objects using phased array radar, as described in more detail elsewhere. For example, the controller/processor 159 of radar system 132 and/or any other component(s) may perform or direct operations of, for example, the methods and/or other processes as described. The memory 160 may store data and program codes for base station 150. A scheduler 162 may schedule transmission of the signal towards the targets or objects for detection at regular time intervals.

As described above, each radar system 132 may include an antenna system that is capable of transmitting and receiving high frequency detection signals. In some embodiments, each antenna system may be implemented as an array antenna system. Antenna arrays, including phased array antenna systems, can dynamically adjust their radiation patterns to focus energy in a desired direction, enhancing the chances of non-line-of-sight (NLOS) communication. Phased array antenna systems are known for their adaptability, as they can dynamically adjust their beam patterns without mechanical movement. This flexibility is especially valuable for satellites in NTN configurations, where efficient communication with multiple ground-based stations and user equipment may be beneficial as the satellite orbits the Earth. Additionally, lower-frequency signals tend to diffract and penetrate obstacles more effectively than higher-frequency signals. Further, when the wavelength of the signal is comparable to the size of the obstacle signals can bend or diffract around obstacles.

In some embodiments, each antenna system may be implemented as a phased array antenna system. One non-limiting example of a phased array antenna system will now be described with reference to FIG. 1E, which is a block diagram of an exemplary phased array antenna system in which aspects of the technology may be employed. The phased array antenna system 170 may also be referred to as electronically steerable or scanned array, which may be used in any of the embodiments disclosed herein.

Any of the disclosed embodiments may also be implemented using a digital beamforming (DBF) phased array, which has a digital receiver/exciter at each element in the array. The signal at each element is digitized by the receiver/exciter, so that antenna beams can be formed digitally in a field programmable gate array (FPGA) or the array computer. This approach allows for multiple simultaneous antenna beams to be formed, e.g., by grouping the radiating elements into sub-groups.

The transmitter TX generates the signal, which is applied to a corporate feed 185, which splits the signal to be delivered to each of the radiating elements 175. Prior to reaching the radiating element, the signal from the feed passes through the corresponding phase shifter 180 such that the phase of the signal in each delay line is changed by an individual amount to cause the beam to steer. The phase shifters 180 can also be controlled by an on-chip processor or baseband processor. The range of each phase shifter can be quantized into a look-up table (LUT). The beam can be steered by quickly retrieving a phase value from the memory. The reverse happens for reception.

The example illustrated in FIG. 1E is a passive phased array or passive electronically scanned array (PESA), which is a phased array in which the antenna elements are connected to a single transmitter and/or receiver. However, the disclosed embodiments are not limited to PESA, but rather encompass any electronically steerable antenna. For example, an active phased array or active electronically scanned array (AESA) may also be used. AESA is a phased array in which each antenna element has an analog transmitter/receiver (T/R) module (TRM) which creates the phase shifting to electronically steer the antenna beam. Any of the disclosed embodiments may also be implemented using a digital beam forming (DBF) phased array, which has a digital receiver/exciter at each element in the array. The signal at each element is digitized by the receiver/exciter, so that antenna beams can be formed digitally in a field programmable gate array (FPGA) or the array computer. This approach allows for multiple simultaneous antenna beams to be formed, e.g., by grouping the radiating elements into sub-groups.

In general, it should be appreciated that each antenna may be any electronically steerable antenna having plurality of radiators, such as the phased array antenna similar to the example illustrated in FIG. 1E. For simplicity, the disclosure provided herein uses the term “phased array antenna”, but it should be appreciated that the term encompasses any electronically steerable antenna having plurality of radiators forming a radiation pattern the direction of which can be steered electronically.

Referring again to FIG. 1A, when the antenna system of each radar system 132 is implemented as a phased array antenna system, each phased array antenna system may dynamically steer beams and provide coverage to different locations as the satellite 108 moves across the sky. Stated differently, each phased array antenna system can dynamically steer and shape the radiation pattern of the antenna, making it a useful component for establishing efficient and reliable communication links between satellites 108 and ground-based stations.

Each phased array antenna system may be capable of both transmitting and receiving signals, and may be designed to provide directional control over the transmitted and received electromagnetic signals. For example, when transmitting, each phased array antenna system may be configured to generate a beam of radio waves. In this context, a beam refers to a focused or directed signal that is transmitted from the satellite's antenna to a specific area on the Earth's surface. The satellite's antenna system is designed to concentrate the signal's energy into a narrow region, effectively creating a “beam” of detection signals that covers a targeted geographic area. In other words, a beam may refer to the directed path of radio waves that target specific areas on the Earth's surface to provide object detection services, where a radio wave can refer to a specific type of electromagnetic wave that carries a detection signal with a particular frequency and wavelength. The radio wave includes both the carrier frequency and the modulated information, such as voice, data, or video.

Each phased array antenna system adjusts the phase and amplitude of individual antenna elements to create a focused and directed beam of electromagnetic waves. By carefully controlling the phase relationships of the signals emitted from each element, the antenna can steer the beam's direction without physically moving the entire antenna structure. This directed beam allows the satellite to target specific areas on the Earth's surface for detection.

By contrast, when the phased array antenna system is in receiving mode, it utilizes the same principles of phase and amplitude control to selectively receive signals from a particular direction. The received signals are then combined coherently to enhance the sensitivity of the antenna in that specific direction. This directional receiving capability is useful for efficiently capturing signals from the desired sources while reducing or minimizing interference from other directions.

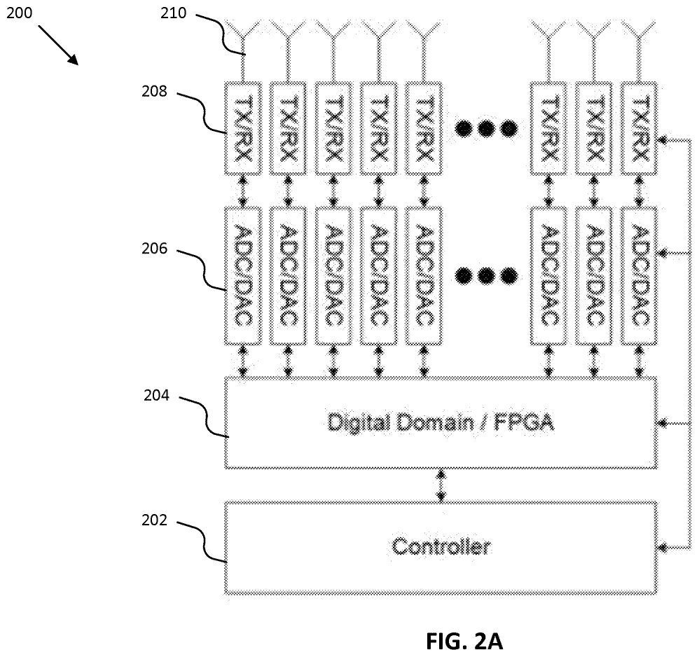

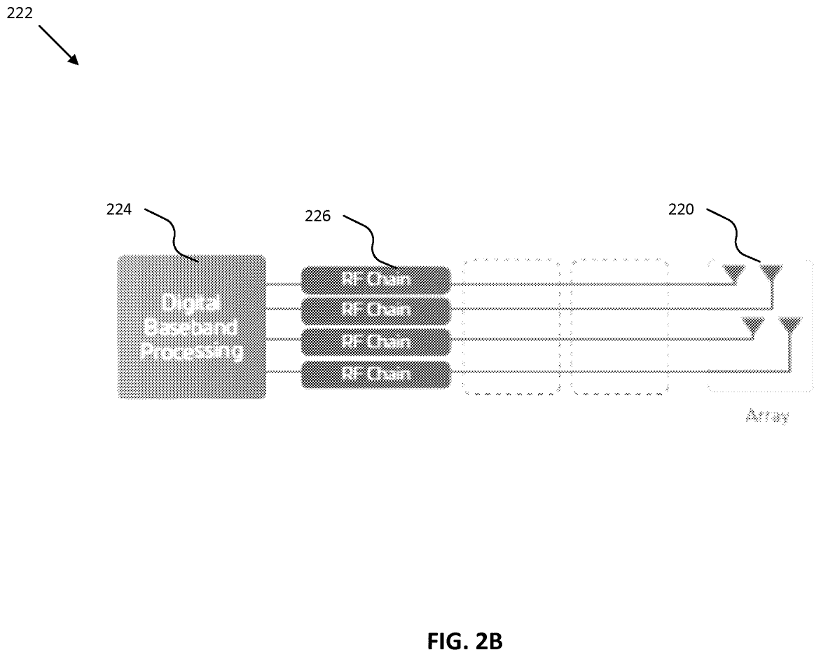

FIG. 2A is a diagram illustrating a digital beamformer 200 for digital beamforming according to aspects of disclosed technology. The digital beamformer 200 enables precise beam steering, adaptive interference mitigation, and enhanced target tracking.

The digital beamformer 200 includes antenna elements 210 that collectively form a phased array; a digital baseband processor 202/204 that includes a controller 202 and an FPGA 204; and an RF chain module 206/208 for each antenna element 210 (with each RF chain module 206/208 including conversion devices 206 and a transmit/receive (TX/RX) module 208). The conversion devices 206 may also be referred to below as an ADC/DAC module 206. In other words, each antenna elements 210 has an associated RF chain module that includes ADC/DAC devices 206 and an associated TX/RX module 208, which may also be referred to as a TRM herein.

The digital beamformer 200 includes antenna elements 210 that collectively form a phased array; a digital baseband processor 202/204 that includes a controller 202 and an FPGA 204; and an RF chain module 206/208 for each antenna element 210 (with each RF chain module 206/208 including conversion devices 206 and a transmit/receive (TX/RX) module 208). The conversion devices 206 may also be referred to below as an ADC/DAC module 206. In other words, each antenna elements 210 has an associated RF chain module that includes ADC/DAC devices 206 and an associated TX/RX module 208, which may also be referred to as a TRM herein.

The controller 202 manages overall beamformer operation, controlling data flow between the RF chain module 206/208 and digital processing units of the FPGA 204. It executes high-level system commands such as beam steering, adaptive interference cancellation, and target tracking. The FPGA 204 executes high-speed parallel processing tasks, including beamforming weight calculations, real-time FFT/IFFT processing, and digital filtering. Implementing the beamforming processing in Field Programmable Gate Arrays (FPGAs) 204 can provide benefits in both density and reconfigurability. It allows for flexible reconfiguration of signal processing tasks to adapt to different radar operating modes. Algorithms and configurations can be swapped in via firmware updates instead of expensive hardware changes, allowing for mode changes, optimizations, and implementation of other capabilities/requirements

The antenna elements 210 are individual radiating structures that transmit and receive. The antenna elements 210 convert electrical signals into electromagnetic waves (transmission) and vice versa (reception). In a digital beamforming system, antenna elements 210 are arranged in a phased array configuration to form a phased array antenna, which can enable precise electronic beam steering. To explain further, the signal from each element 210 is adjusted in phase and amplitude to shape and steer the beam. This enables spatial filtering, suppressing interference and noise while enhancing the detection of desired signals.

Each antenna element 210 has a dedicated RF chain 206/208 that converts signals between RF and digital domains. Each RF chain 206/208 converts signals between radio frequency (RF) and digital baseband for processing. In other words, each RF chain 206/208 converts RF signals into digital form for processing in the baseband processor (ADC in the receive path), and also converts processed digital signals back into RF for transmission (DAC in the transmit path). Each RF chain 206/208 maintains phase coherence across all antenna elements 210 to ensure precise beamforming. To explain further, each RF chain includes ADC/DAC module 206 (that includes Analog-to-Digital and Digital-to-Analog converters) and a TX/RX module 208 to manage signal transmission and reception. The Analog-to-Digital Converter (ADC) portion of the ADC/DAC module 206 converts received analog RF signals into digital data for processing in the digital baseband processor, whereas the Digital-to-Analog Converter (DAC) portion of the ADC/DAC module 206 converts digitally processed signals back into analog RF signals for transmission. The Transmit Module (TX Module) of the TX/RX module 208 includes power amplifiers and mixers to boost and modulate the signal before sending it to the antenna for transmission. The Receive Module (RX Module) of the TX/RX module 208 includes low-noise amplifiers (LNAs) and mixers to amplify and downconvert incoming signals before digital processing.

Each of the LEO satellites can include a very large aperture (VLA) phased array antenna configured for radar operations that includes an array of thin-film antenna elements; an onboard signal processing system; a transmitter; a receiver; and a digital beamforming processor, which may be part of the onboard signal processing system or a separate processor. Each of the array of thin-film antenna elements may be driven by a respective digital-to-analog converter (DAC) coupled to a power amplifier (PA) for transmitting the radar signals. For example, each radiating antenna element may have an associated DAC that converts the digital signal to be transmitted to an analog waveform that is then amplified by an associated power amplifier (PA) that can radiate several watts of power. Further, each of the array of thin-film antenna elements may be coupled to a respective low-noise amplifier (LNA) 218 and an analog-to-digital converter (ADC) 216 to digitize received signals. For example, each antenna element may also have an associated LNA that can be switched to the antenna (when the power amplifier is off), and the signals from the LNAs can be sampled by an associated ADC and converted to digital signals.

FIG. 2B is a block diagram illustrating a digital beamforming architecture 222 according to aspects of disclosed technology. The beamforming architecture includes a digital baseband processor 224, radio frequency (RF) chains 226 (one per antenna element), and antenna elements 220 that collectively provide a phased array antenna. This architecture 222 enables real-time adaptive beamforming for the LEO satellite-based radar system that allows for phased array surveillance and space-based moving target tracking. Each component plays a crucial role in steering and shaping the radar beam digitally, improving target tracking, resolution, and interference mitigation, and will now be described in greater detail below.

Each antenna element 210 is associated with its own RF chain 226 allowing the system to create multiple beams at the same time, serving many users simultaneously. This flexibility makes it excellent for dense environments. In a digital beamforming processor, each RF chain typically includes components like a low-noise amplifier, down-converter, digital-to-analog converter (DAC), and analog-to-digital converter (ADC), enabling signal processing and transmission/reception for each antenna element.

In the embodiment of FIG. 2B, the digital baseband processor 224 is the core computational unit of the digital beamformer 222. It processes received radar signals in the digital domain, performing beamforming operations such as weighting, summation, and filtering to electronically steer and shape the beam. This processor 224 applies beamforming weights to signals from multiple antenna elements 220 and implements adaptive signal processing algorithms for interference rejection and target detection. Additionally, it performs Fourier transforms (FFT/IFFT) for frequency-domain analysis and synchronizes signals across multiple elements to form a coherent beam. Although not shown in FIG. 2B, key subcomponents of the digital baseband processor 224 can include, but are not limited to, analog-to-digital converters (ADCs) and digital-to-analog converters (DACs), which handle signal conversion between analog and digital domains, and field-programmable gate arrays (FPGAs) or digital signal processors (DSPs), which execute high-speed digital filtering and beamforming computations. A fast Fourier transform (FFT) engine is often included to facilitate spectral analysis, while a beamforming algorithm processor controls phase and amplitude weighting. Memory and buffering components are also integrated to store received signals before processing, ensuring synchronization and coherence across multiple signals.

The antenna elements 220 serve as the radiating and receiving components of the system, converting electrical signals into electromagnetic waves during transmission and vice versa during reception. These elements 220 collectively form a phased array, where individual signals are adjusted to create a focused, electronically steerable beam. This capability enables spatial filtering by steering nulls toward interference sources. Various types of antenna elements 220 can be used depending on the implementation, and the choice of antenna type depends on the frequency range, beamwidth requirements, and platform constraints.

Each antenna element 220 of phased array is associated with a dedicated RF chain 226, which is responsible for converting signals between radio frequency (RF) and intermediate frequency (IF) or baseband for digital processing. The RF chain 226 amplifies, filters, and mixes RF signals to ensure proper signal integrity and phase coherence across the entire array. An important component in the receive path is the low-noise amplifier (LNA), which amplifies weak incoming signals while minimizing noise to preserve signal quality. In the transmit path, a power amplifier (PA) boosts the signal strength before transmission to ensure adequate radiated power. A mixer is used to convert RF signals to IF or baseband using a local oscillator (LO), which generates stable frequency references for frequency translation. Band-pass filters (BPFs) are included to remove unwanted frequency components and interference. Additionally, phase shifters and attenuators play a crucial role in adjusting the phase and amplitude of signals before digitization, allowing precise control of beamforming patterns.

By integrating high-performance digital signal processing, electronically steerable antenna arrays, and advanced RF front-end components, digital beamforming processor 222 provide superior flexibility and precision in radar sensing and target detection.

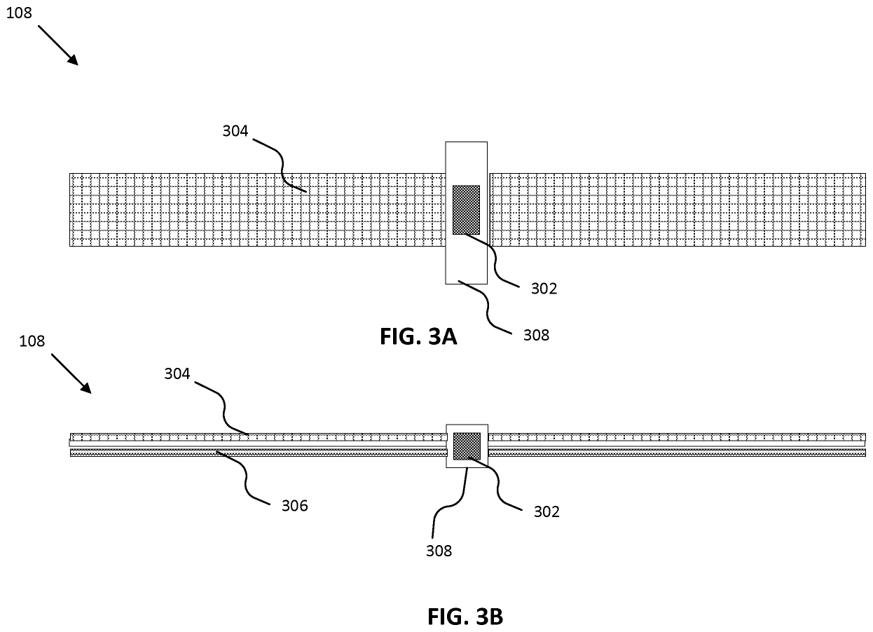

FIGS. 3A and 3B are diagrams illustrating top and front views of one non-limiting example of satellite 108 in which aspects of the technology may be practiced. The satellite 108 comprises of a flight software 406 and may include two different sides that are illustrated in FIGS. 3A and 3B that are opposite to each other. As used herein, a “side” can refer to a structure or substructure. As an example, a side of the satellite 108 may be thin film of material having one or more other elements formed thereon. A side may also refer to a structure that includes multiple layers.

As illustrated in FIG. 3A, the first side includes plural solar cells, which collectively define one or more solar panels 304, and a support substrate 308. In the illustrative embodiment, each of solar panels 304 is supported on support substrate, and may include any number of solar cells. The solar panels may be flexible thin film solar panels. The particular thin film solar panels that are utilized may vary depending on the implementation as there are numerous examples of thin film solar panels which can be utilized in conjunction with the embodiments described herein.

The onboard signal processing system may be coupled to each of the array of thin-film antenna elements via a respective high-speed data link (e.g., a high-speed data interconnect configured to transfer digitized signal data between the antenna elements and the digital beamforming processor, such as thin fiber optic cabling or high frequency digital wiring). For example, in one implementation, the respective high-speed data links comprise fiber optic links to minimize latency and reduce electromagnetic interference (EMI).

Each VLA phased array antenna comprises: a ground plane, and an array of thin-film antenna elements mounted on a carrier layer, which in one embodiment, may be part of a multilayer structural element. Each VLA phased array antenna is ultra-thin and ultra-lightweight (e.g., has a mass that is less than or equal to 10 kilograms in one non-limiting implementation). Each VLA phased array antenna has a large number (e.g., 1000 or more) of thin-film antenna elements that are distributed over a large area (e.g., an area 420 m² or more when deployed in one non-limiting implementation).

The combination of thin-film materials for the antenna elements, lightweight polymer films for the carrier layer and supporting layer (such as polyethylene terephthalate (PET) film, nylon film, mylar film, polyamide film, or polyimide film), thin conductive layers (such as metalized layers) for the ground plane, and printed conductive ink electrodes may enable achieving both a large deployed area (e.g., 400 m² or more) and a low mass (e.g., 10 kilograms or less) simultaneously. In some aspects, this low mass may be achieved because each of these components contributes to weight reduction compared to conventional antenna structures: thin-film antenna elements may weigh significantly less than traditional metallic antenna elements; polymer films used for the carrier and supporting layers may be substantially lighter than rigid substrates; metalized layers may provide ground plane functionality with minimal material; and printed conductive ink electrodes may eliminate the need for heavier conventional wiring and connectors.

The technical advantages of this combination of large aperture and low mass may be significant. The large aperture may enable narrower beams, which can result in reduced radar clutter for easier target identification. Additionally, narrower beams may require less transmitted power to achieve equivalent detection performance, thereby reducing power consumption requirements on the satellite. The low mass may reduce launch costs per satellite, which can enable deployment of larger constellations for improved global coverage. In some cases, the reduced mass per satellite may allow multiple satellites to be launched on a single launch vehicle, further reducing overall deployment costs.

The ultra-thin and ultra-lightweight construction of the VLA phased array antenna may also facilitate the folded or rolled launch configuration. Because the thin-film materials and polymer films are flexible, the multilayer structural element including the VLA phased array and ground plane may be compactly stored during launch and then deployed to its full operational area once in orbit. This may allow satellites with very large aperture antennas to be launched using standard launch vehicles that would otherwise be unable to accommodate rigid antenna structures of comparable size.

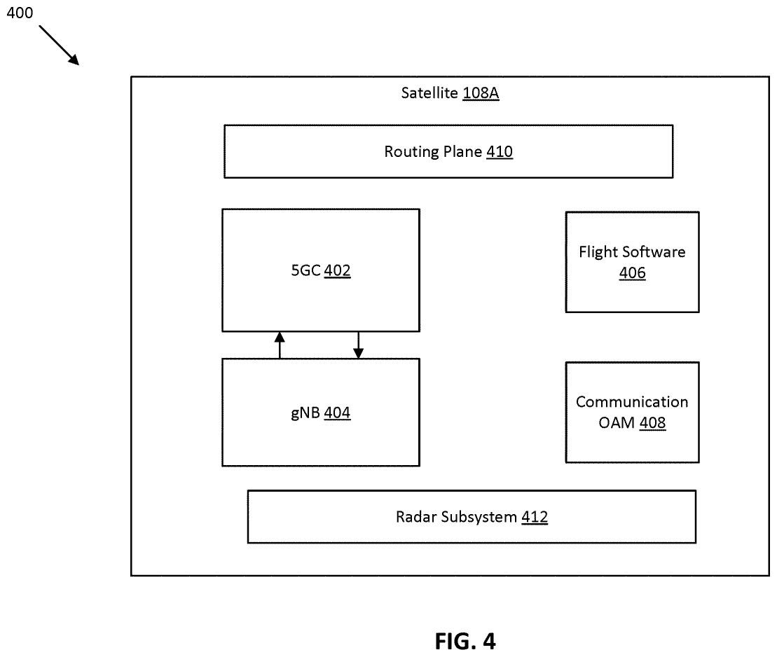

FIG. 4 is a block diagram 400 of the satellite 108A of the system environment 100 according to aspects of the disclosed technology. Each of the satellites, such as the satellite 108A, may be a communications satellite that may be configured to implement a 5G core network (5GC) 402 and a 5G base station, i.e., gNodeB (gNB) 404, that communicates with at least one UE of the plurality of UE 106. The satellite 108A further includes a flight software 406, a communication operation and management agent (OAM) 408, a routing plane 410, and a radar subsystem 412. The 5GC 402 may serve as a control center for the 5G communications network. The 5GC 402 may be configured to govern all the protocols, network interfaces, and services that allow the 5G communications network to function seamlessly. The 5GC 402 may comprise a set of 5G components from the plurality of 5G components. In one embodiment, the third set of 5G components may include the AMF, the SMF, the UPF, the UDM, the UDR, and the AUSF.

The 5GC OAM 408 may be configured to continuously monitor the 5GC network components, detecting any anomalies or faults, handle configuration changes for various network functions based on service requirements and policies. The 5GC OAM 408 may be further configured to monitor network performance metrics (such as latency, throughput, and resource utilization), security policies, access controls, and threat detection, facilitate software upgrades for network functions, and optimize resource usage to enhance overall network performance.

The gNB 404 on the satellite 108A is an operative component of the satellite communication systems, serving as an access point for two-way data transmission between Earth-based UEs 106 and the satellites 108 as well as between two or more of the satellites 108. The gNB 404 may be housed within (or as part of) the satellite's payload and may include transceivers and antennas designed to facilitate seamless communication across vast distances. The gNB 404 plays a role in relaying, amplifying, and routing signals between terrestrial devices, such as the UEs 106, and the satellites 108, ensuring robust and efficient data transfer. The gNB 404 is often equipped with advanced signal processing capabilities, enabling functions like modulation, demodulation, encoding, and decoding to optimize the quality and reliability of communication links 114, and can be useful for various satellite-based services, including global broadband internet, broadcasting, navigation, internet of things (IoT) services, and Earth observation.

In one implementation, each satellite 108 may be a 5G Non-Terrestrial Network (NTN) satellite, in which case the gNB 404 may be referred to as a Third Generation Partnership Project (3GPP)-compliant implementation of the 5G base station. The gNodeB includes independent network functions, which implement 3GPP-compliant new radio (NR) radio access network (RAN) protocols namely.

The flight software 406 may be operated on a flight computer (not shown) to serve as the “brain” of the satellite 108A. For example, the flight software 406 may run on a processor embedded in a satellite's avionics. The name “flight software” reflects the location where it executes, i.e. in the satellite, to differentiate from “ground software”, which runs in the ground segment. The flight software 406 may enable the satellite to perform all operations necessary to facilitate the science objective and perform maintenance tasks for the satellite. For instance, the flight software 406 is responsible for managing on-board activities, data processing and satellite health and safety. It is considered a high-risk system because it interacts directly with satellite hardware, controlling virtually most of the onboard systems in real time at various levels of automation.

The flight software 406 may vary depending on the implementation. In general, the flight software 406 may include an operating system (OS) layer that interfaces with a middleware layer via OS application programming interfaces (APIs), and an application layer that interfaces with the middleware layer via middleware APIs. The OS APIs may be encapsulated and a uniform Application Program Interface (API) may be provided by the OS layer. Any operating system that supports this uniform API may be used in the avionics system. The middleware layer may serve as common service platform between the operating system layer and application layer. The middleware layer has standard program interfaces and protocols, and may realize the data exchange and cross support among different hardware and operating system. The application layer includes any mission application software or “mission applications.” The application layer includes most of the common functions of avionics system. The implementation of this layer may be different for different projects.

The communication OAM 408 may be configured to perform various task related to the satellite operations such as health monitoring to ensure the satellite's proper functioning, orbit control to adjusting the satellite's position and trajectory, payload management to optimizing payload usage, resource allocation to allocate bandwidth, power, and other resources, security, and fault detection and recovery. The routing plane 410 may handle data routing and forwarding of the data associated with the 5G communications between the centralized communication server 102 and the satellites 108 via the gateways 104 and data transfer between the satellites 108. In one embodiment, the satellite 108A may include a security plane that may ensure network security and protection against threats.

The radar subsystem 412 may be configured to perform various tasks related to radiation of waves such as detection of a speed and location of an object or target 134. The radar subsystem 412 may be configured to determine when the radar needs to transmit the waves and to receive the reflected waves. Based on the comparison of the transmitted signal and the reflected signal, the radar subsystem 412 may be configured to perform various operations related to object/target detection and tracking.

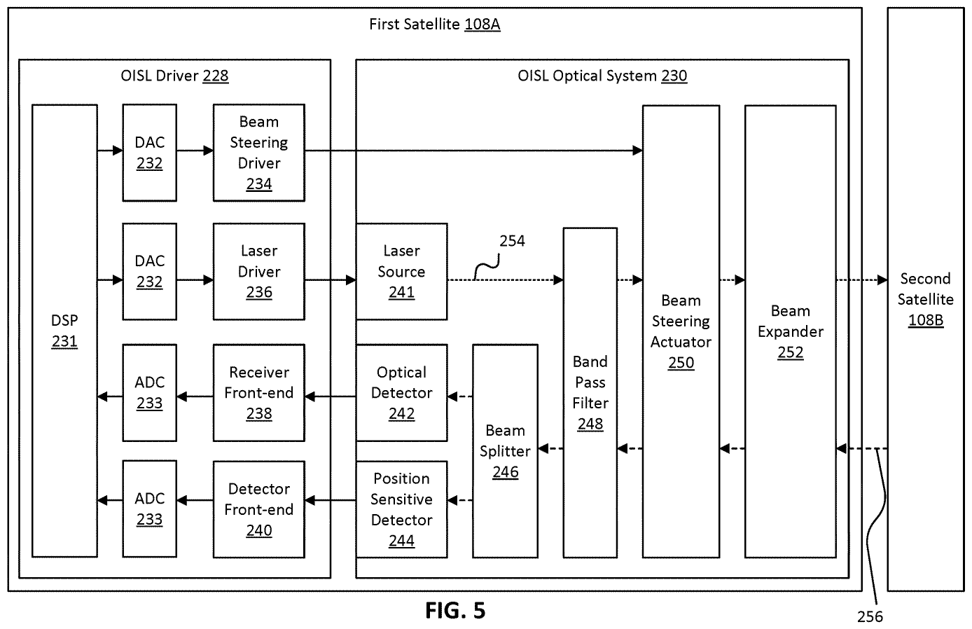

FIG. 5 is a block diagram that illustrates an optical inter-satellite link (OISL) system associated with the first satellite 108A and the second satellite 108B according to aspects of the disclosed technology. In one embodiment, the OISL system is a monostatic system with a small diameter collimated beam in the inside, both in transmission and reception. The OISL system of the first satellite 108A may include an OISL driver 228 and an OISL optical system 230.

The OISL driver 228 may be configured to manage the communication protocols and data transmission between the satellites 108A and 108B. The OISL driver 228 may ensure that the data transferred between the satellites 108A and 108B is correctly formatted, transmitted, and received, adhering to the OISL standard's specifications. In one embodiment, the OISL driver 228 may comprise a digital signal processor (DSP) 231, DACs 232, ADCs 233, a beam steering driver 234, a laser driver 236, a receiver front-end 238, and a detector front-end 240. Further, the OISL optical system 230 may comprise a laser source 241, an optical detector 242, a position sensitive detector 244, a beam splitter 246, a band-pass filter 248, a beam steering actuator 250, and a beam expander 252.

In one embodiment, the digital signal processor 231 may be coupled to the DACs 232 and the ADCs 233 and may be configured to transmit digital signals to the DACs 232 and receive digital signals from the ADCs 233 for beam steering operations such as transmission of the transmission beam and reception of the reception beam. The DACs 232 may be coupled to the beam steering driver 234 and the laser driver 236 and may be configured to convert the digital signals received from the DSP 231 to analog signals and provide the analog signals to the laser driver 236 for generation of a driving signal and to the beam steering driver 234 to generate a control signal. It will be apparent to a person skilled in the art that although in the current embodiment, two DACs 232 are included in the OISL driver 228 such that the beam steering driver 234 and the laser driver 236 are coupled to one DAC each, the scope of the present disclosure is not limited to it. In alternate embodiments, any suitable number of DACs may be included in the OISL driver 228, for example a single DAC may be coupled to both the beam steering driver 234 and the laser driver 236, without deviating from the scope of the present disclosure. The ADCs 233 may be coupled to the receiver front-end 238 and the detector front-end 240 and may be configured to convert the analog signals received from the receiver front-end 238 and the detector front-end 240 to digital signals and provide the converted digital signals to the DSP 231 for controlling the beam steering operation. It will be apparent to a person skilled in the art that although in the current embodiment, two ADCs 233 are included in the OISL driver 228 such that the receiver front-end 238 and the detector front-end 240 are coupled to one ADC each, the scope of the present disclosure is not limited to it. In alternate embodiments, any suitable number of ADCs may be included in the OISL driver 228, for example a single ADC may be coupled to both the receiver front-end 238 and the detector front-end 240, without deviating from the scope of the present disclosure.

Further, the laser source 241 may be coupled to the laser driver 236 and may be configured to receive the driving signal and generate a transmission beam based on the driving signal. In one embodiment, the driving signal may control one or more parameters, such as a beam width, beam intensity, and the like, of the transmission beam. The laser source 241 may be configured to transmit the transmission beam to the beam steering actuator 250 via the band-pass filter 248. Additionally, the beam steering driver 234 may be configured to provide the control signal to the beam steering actuator 250. Based on the control signal, a position of the beam steering actuator 250 is adjusted to steer the transmission beam towards the second satellite 102B via the beam expander 252. In one embodiment, the beam expander 252 may be configured to expand the transmission beam and transmit the expanded transmission beam towards the second satellite 102B.

It will be understood by a person skilled in the art that the second satellite 108B may include an OISL driver (not shown) and an OISL optical system (not shown) which is structurally and functionally similar to the OISL driver 228 and the OISL optical system. Thus, the satellite 108B may generate a beam and transmit the generated beam towards the first satellite 108A in a similar manner as described for the transmission beam by satellite 108A.

### Satellite Structure

In one embodiment, the LEO satellite may be a multilayer structure and a carrier layer can be part of the multilayer structural element of the LEO satellite. In one embodiment, the multilayer structural element may be deployed via a deployable support structure. The structural element may be in a folded or rolled configuration prior to deployment. In one implementation, the deployable support structure may include carbon fiber booms that extend from a compact launch configuration to deploy the multilayer structural element (including VLA phased array and the ground plane) by uncurling to form a rigid support structure when deployed that holds the VLA phased array and the ground plane in place. In one embodiment, the multi-layer structural element has a first side and a second side opposite the first side, where the first side comprises a plurality of electrodes (each of which functions as one of the thin-film antenna elements) formed on the carrier layer, and where the second side comprises a support substrate that is separable from the electrodes by a specific separation distance and serves as the ground plane for the antenna element. In one implementation, the electrode may be printed on the carrier layer, for example, as a conductive spiral.

In one implementation, the support substrate is configured to support an optional thin-film solar panel system. The thin-film solar panel system and the electrode can be flexible. In one implementation, the support substrate may include a supporting layer (e.g., where the thin-film solar panel system overlies one surface of the supporting layer), and a thin conductive layer that overlies another surface of the supporting layer. The thin conductive layer may serve as the ground plane of the antenna element. For instance, in one implementation, the thin conductive layer may be a metalized layer, and the supporting layer and the carrier layer may each comprise one or more of: polyethylene terephthalate (PET) film, a nylon film, a mylar film, a polyamide film, and a polyimide film.

### Other Features of the Disclosed Space-Based radar systems

As noted above, each of the thin-film antenna elements is configured to transmit and receive electromagnetic signals. A transmitter may be configured to generate and transmit a linear frequency modulated radar signals (e.g., pulses) from the array of thin-film antenna elements toward the Earth's surface, while a receiver may be configured to receive reflected radar signals from the array of thin-film antenna elements. The reflected radar signals are reflected from objects on or near the Earth's surface. In one embodiment, the transmitter and receiver are time-multiplexed such that the transmitter is disconnected from the antenna during reception to minimize interference. For example, a processor of the system can connect the transmitter to its antenna, transmit a signal pulse toward the Earth and then disconnect its transmitter from the antenna and turn off its transmitter. The processor can then connect the receiver to the antenna and turn on its receiver to listen for a returning pulse (echo of the pulse) caused by the radar signal being reflected by an object or target in its path. When the reflected pulse (echo) signal can be received by the antenna, sampled by the onboard processor, and autocorrelated with the transmitted pulse signal (chirp) to provide radar pulse compression and improve the received signal-to-noise ratio. To explain further, in one embodiment, the onboard signal processing system may execute signal processing algorithms to: generate and shape the transmitted radar signal into a Linear Frequency Modulated (LFM) VHF/UHF carrier (or chirp); sample the reflected radar signal; perform autocorrelation between the transmitted radar signal and reflected radar signal to provide radar pulse compression and enhance signal-to-noise ratio (SNR), wherein the autocorrelation processing for pulse compression occurs in real-time; and digitally form and steer multiple narrow radar beams over a wide field of view.

The space-based radar system supports multi-beam operation thereby allowing the VLA phased array antenna to simultaneously form and steer multiple independent beams. For example, the satellite's onboard signal processor can be used to create multiple narrow beams that can be steered (moved or scanned) over a wide angle of view. Thus, a wide area can be illuminated by the radar simultaneously by the multiple beams and then sequentially as these multiple beams are moved from location to location within the satellite's field of view. In some embodiments, each independent beam may be assigned to a different communication channel, frequency band, or spatial region.

In one embodiment, the space-based radar system is configured to operate over a wideband frequency range, and dynamically adjust beamforming parameters to optimize performance across different frequencies. In one embodiment, the space-based radar system may further include a control system configured to optimize beamforming parameters based on algorithms or external command inputs. For example, the control system may be configured to receive external commands from a remote operator or an autonomous artificial intelligence (AI) module for real-time beam control and optimization.

The digital beamforming processor may be configured to execute beamforming algorithms on the radar signal from the transmitter and the reflected radar signals from the receiver to generate multiple narrow radar beams that are electronically steered to sequentially scan a wide area of the Earth's surface. In one embodiment, the beamforming processor is configured to implement distributed beamforming, wherein multiple independent systems coordinate transmission and reception to form a coherent array.

In one embodiment, the beamforming processor is configured to dynamically adjust phase and amplitude weights of the antenna elements to optimize beam direction and shape. For example, the digital beamforming processor may be configured to apply digital phase and amplitude weighting to transmitted signals to form and steer one or more directional beams. As another example, the digital beamforming processor may be configured to apply digital filtering and signal correlation to received radar signals to enhance signal-to-noise ratio (SNR) and suppress interference. As another example, the digital beamforming processor may be configured to dynamically adjust beam parameters in response to changing signal conditions. For example, the beamforming processor may be configured for adaptive beamforming to continuously adjust beam parameters based on real-time environmental conditions or interference levels.

In one embodiment, the digital beamforming processor may be an agile digital beamforming processor. The agile digital beamforming processor processes signals in the digital domain has the ability to dynamically form and steer multiple independent beams in real time from a single antenna array using advanced signal processing techniques. For example, the agile digital beamforming processor may be configured to dynamically control the phase and amplitude of radar signals across the array of thin-film antenna elements to rapidly form, steer, and reconfigure directional beams in real time. The agile digital beamforming processor can make near-instantaneous changes to beam direction, allowing for real-time tracking of fast-moving objects, such as vehicles, aircraft, satellites, ground objects/targets or mobile users. This allow different signals need to be directed to different locations simultaneously. The agile digital beamforming processor can rapidly adjust beam direction to track moving objects or optimize signal quality. For example, in some cases, the agile digital beamforming processor can dynamically adjust beam patterns to minimize interference and maximize signal strength. It enables precise, adaptable control over signal directionality, making it highly valuable in applications such as satellite communications and radar.

In one embodiment, the beamforming processor utilizes minimum variance distortionless response (MVDR), least mean squares (LMS), or eigenvalue decomposition (EVD) algorithms for adaptive interference suppression.

In one embodiment, the beamforming processor implements spatial filtering to mitigate interference from undesired sources while enhancing signal reception from desired sources.

In accordance with the disclosed embodiments, larger apertures enable narrower beams, resulting in less radar clutter for easier target identification and require less power. The larger aperture of the VLA phased array antenna enables low UHF frequency operation of the VLA phased array antenna, which is beneficial for a number of reasons that will be discussed herein. For example, in one non-limiting embodiment, each VLA phased array antenna operates in an ultra-high frequency (UHF) band of radio frequencies that can range between 300 and 600 megahertz (MHz) for radar operation. For instance, each VLA phased array antenna can produce focused beams with 2° beamwidth at 350 MHz. In another non-limiting embodiment, each VLA phased array antenna can operate, for example, in a very-high frequency (VHF) band of radio frequencies that range between 30 and 300 megahertz (MHz). By operating at relatively low frequencies and hence relatively long wavelengths (with respect to those of conventional optical and higher-frequency radar systems), the disclosed radar systems can operate through any weather conditions and are not obstructed by clouds or storms for continuous custody. For instance, the VLA phased array antenna can transmit radar signals and receive reflected radar sign through obstacles such as clouds. Likewise, the disclosed space-based radar systems can penetrate dense foliage, buildings, and water to detect objects and targets that might otherwise be obscured from optical and higher-frequency radar systems.

In one embodiment, the space-based radar system is an Active Electronically Scanned Array (AESA)-based radar system that use many transmit/receive modules (TRMs) to independently control the phase and amplitude of radar beams, allowing for multiple, agile radar beams and enhanced capabilities like simultaneous air-to-air and air-to-ground tracking. AESA radar systems are considered an active phased array system, which includes an array of antennas which form a beam of radio waves that can be electronically aimed in different directions. AESA radar systems utilize a large number of TRMs, each connected to an antenna element, allowing for independent control of each beam's phase and amplitude. This independent control enables the generation of multiple, simultaneous radar beams, allowing for simultaneous tracking of multiple targets in different directions. AESA radar systems provide aircrews with a comprehensive view of the airspace, enabling them to track and engage targets more effectively. The also have ability to transmit energy at the target much faster (at the microsecond level), which allows for early track formation and accurate tracking of maneuvering targets. AESA radar systems can spread their signal emissions across a wider range of frequencies, making them more difficult to detect and jam. The AESA-based radar system may use numerous onboard signal processing gains including pulse compression, coherent integration, multi-pulse integration, and digital pulse-shaping to maintain a low per element power level.

In some embodiments, each of LEO satellites may include an optical intersatellite communication system that allows that LEO satellite to communicate with other LEO satellites in the constellation via intersatellite links. In other words, optical intersatellite links may allow the LEO satellites to communicate with other LEO satellites in the constellation. Each of LEO satellites may also be capable of directly communicating with ground stations.

In some embodiments, each of LEO satellites may further include a thin-film solar panel system. Power for all circuitry used on a LEO satellite can be generated by onboard thin film printed solar panels that are mounted on the back side of the satellite antenna's ground plane. In one implementation, the thin-film solar panel may be mounted, for example, opposite the array of thin-film antenna elements. For example, in one embodiment, unique thin-film solar panels have been demonstrated to achieve at least 16 times the power-to-weight (watts/kg) efficiency of conventional rigid silicon-based triple junction solar panels. This can provide a power source that is over 16× more efficient in terms of kW/kg than conventional silicon-based triple junction solar panels. This can allow the thin-film solar panel to generate electrical power (e.g., up to 15 kW) that power various subsystems of LEO satellite including the onboard signal processing system. The integration of these thin-film solar panels on the LEO satellite can enable low radar cross section, while also providing high onboard compute power for signal processing.

In one embodiment, the space-based radar system uses Doppler variation to remove clutter and detect objects.

In one embodiment, the space-based radar system includes multiple sensors, and raw data from multiple sensors at multiple angles can be combined for deeper analysis.

In one embodiment, the beamforming and signal processing algorithms are configurable via software updates to adapt to different radar scanning modes.

In one embodiment, the space-based radar system may have a mean time to detection of three (3) seconds or less, a minimum radar cross section of 10 cm², a beam azimuth to target of 45°, and a minimum detectable velocity (MDV) that is subsonic.

The three-second mean time to detection may be enabled by the fast beam hopping and millisecond-speed scanning capabilities of the digital beamformer, which can rapidly cycle through the field of regard. This agile scanning approach allows the system to survey large areas quickly while maintaining sufficient dwell time on each beam position for target detection.

The 10 cm² minimum radar cross section detection capability may be achieved through the combination of several system features. The very large aperture (VLA) phased array antenna provides high antenna gain, while pulse compression via autocorrelation processing enhances the signal-to-noise ratio. Additionally, coherent integration across multiple pulses and deep signal processing algorithms that leverage machine learning and artificial intelligence techniques may further improve the system's ability to detect small radar cross section objects.

The 45° beam azimuth to target capability may be enabled by the digital beamforming processor's ability to electronically steer beams by dynamically adjusting phase and amplitude weights across the array of thin-film antenna elements. This electronic beam steering allows the radar to direct beams at wide angles from boresight without mechanical movement of the antenna structure.

The subsonic minimum detectable velocity (MDV) may be achieved through Doppler processing and moving target indication (MTI) capabilities. The system uses Doppler variation to distinguish moving objects from stationary clutter, enabling detection and tracking of slow-moving targets such as ground vehicles, ships, and low-speed aircraft.

The onboard signal processing system may be configured to execute signal processing algorithms. For example, in one embodiment, the onboard signal processing system is configured to execute deep signal processing (DeepSP) algorithms. Deep signal processing is an advanced approach to signal processing that integrates machine learning (ML), artificial intelligence (AI), and deep neural networks (DNNs) to enhance traditional signal processing techniques. It is particularly useful for extracting relevant insights from complex signals in radar system, for example.

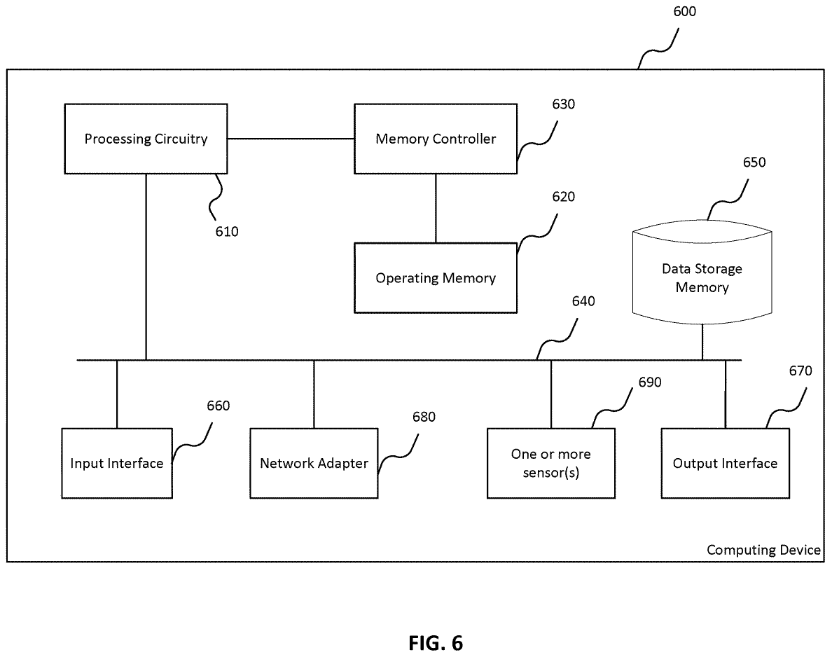

FIG. 6 is a diagram illustrating one example of computing device 600 in which aspects of the technology may be practiced. Computing device 600 may be virtually any type of general-purpose or specific-purpose computing device. For example, computing device 600 may be an example of a processor of the satellite 108, a computing system or device associated with any entity (e.g., satellite 108) as described above with reference to FIGS. 1-5.

As illustrated in FIG. 6, computing device 600 includes processing circuit 610, operating memory 620, memory controller 630, data storage memory 650, input interface 660, output interface 670, network adapter(s) 680, and in some embodiments, one or more sensor(s) 690. Each of these afore-listed components of computing device 600 includes at least one hardware element.

Computing device 600 includes at least one processing circuit 610 configured to execute instructions, such as instructions for implementing the herein-described workloads, processes, or technology. Processing circuit 610 may include a microprocessor, a microcontroller, a graphics processor, a coprocessor, a field-programmable gate array, a programmable logic device, a signal processor, or any other circuit suitable for processing data. The aforementioned instructions, along with other data (e.g., datasets, metadata, operating system instructions, etc.), may be stored in operating memory 620 during run-time of computing device 600. Operating memory 620 may also include any of a variety of data storage devices/components, such as volatile memories, semi-volatile memories, random access memories, static memories, caches, buffers, or other media used to store run-time information. In one example, operating memory 620 does not retain information when computing device 600 is powered off. Rather, computing device 600 may be configured to transfer instructions from a non-volatile data storage component (e.g., data storage component 650) to operating memory 620 as part of a booting or other loading process. In some examples, other forms of execution may be employed, such as execution directly from data storage component 650.

Operating memory 620 may include 4th generation double data rate (DDR4) memory, 3rd generation double data rate (DDR3) memory, other dynamic random access memory (DRAM), High Bandwidth Memory (HBM), Hybrid Memory Cube memory, 3D-staked memory, static random access memory (SRAM), magneto resistive random access memory (MRAM), pseudorandom random access memory (PSRAM), or other memory, and such memory may comprise one or more memory circuits integrated onto a DIMM, SIMM, SODIMM, Known Good Die (KGD), or other packaging. Such operating memory modules or devices may be organized according to channels, ranks, and banks. For example, operating memory devices may be coupled to processing circuit 610 via memory controller 630 in channels. One example of computing device 600 may include one or two DIMMs per channel, with one or two ranks per channel. Operating memory within a rank may operate with a shared clock, and shared address and command bus. Also, an operating memory device may be organized into several banks where a bank can be thought of as an array addressed by row and column. Based on such an organization of operating memory, physical addresses within the operating memory may be referred to by a tuple of channel, rank, bank, row, and column.

Despite the above-discussion, operating memory 620 specifically does not include or encompass communications media, any communications medium, or any signals per se.

Memory controller 630 is configured to interface processing circuit 610 to operating memory 620. For example, memory controller 630 may be configured to interface commands, addresses, and data between operating memory 620 and processing circuit 610. Memory controller 630 may also be configured to abstract or otherwise manage certain aspects of memory management from or for processing circuit 610. Although memory controller 630 is illustrated as single memory controller separate from processing circuit 610, in other examples, multiple memory controllers may be employed, memory controller(s) may be integrated with operating memory 620, or the like. Further, memory controller(s) may be integrated into processing circuit 610. These and other variations are possible.

In computing device 600, data storage memory 650, input interface 660, output interface 670, network adapter 680, and sensors 690 may be interfaced to processing circuit 610 by bus 640. Although, FIG. 6 illustrates bus 640 as a single passive bus, other configurations, such as a collection of buses, a collection of point-to-point links, an input/output controller, a bridge, other interface circuitry, or any collection thereof may also be suitably employed for interfacing data storage memory 650, input interface 660, output interface 670, or network adapter 680 to processing circuit 610.

In computing device 600, data storage memory 650 is employed for long-term non-volatile data storage. Data storage memory 650 may include any of a variety of non-volatile data storage devices/components, such as non-volatile memories, disks, disk drives, hard drives, solid-state drives, or any other media that can be used for the non-volatile storage of information. However, data storage memory 650 specifically does not include or encompass communications media, any communications medium, or any signals per se. In contrast to operating memory 620, data storage memory 650 is employed by computing device 600 for non-volatile long-term data storage, instead of for run-time data storage.

Also, computing device 600 may include or be coupled to any type of processor-readable media such as processor-readable storage media (e.g., operating memory 620 and data storage memory 650) and communication media (e.g., communication signals and radio waves). While the term processor-readable storage media includes operating memory 620 and data storage memory 650, the term “processor-readable storage media,” throughout the specification and the claims whether used in the singular or the plural, is defined herein so that the term “processor-readable storage media” specifically excludes and does not encompass communications media, any communications medium, or any signals per se. However, the term “processor-readable storage media” does encompass processor cache, Random Access Memory (RAM), register memory, and/or the like.

Computing device 600 also includes input interface 660, which may be configured to enable computing device 600 to receive input from users or from other devices, such as sensors 690, in some embodiments. In addition, computing device 600 includes output interface 670, which may be configured to provide output from computing device 600.

In the illustrated example, computing device 600 is configured to communicate with other computing devices or entities via network adapter 680. Network adapter 680 may include a wired network adapter, e.g., an Ethernet adapter, a Token Ring adapter, or a Digital Subscriber Line (DSL) adapter. Network adapter 680 may also include a wireless network adapter, for example, a Wi-Fi adapter, a Bluetooth adapter, a ZigBee adapter, a Long-Term Evolution (LTE) adapter, SigFox, LoRa, Powerline, or a 5G adapter.

Although computing device 600 is illustrated with certain components configured in a particular arrangement, these components and arrangement are merely one example of a computing device in which the technology may be employed. In other examples, data storage memory 650, input interface 660, output interface 670, or network adapter 680 may be directly coupled to processing circuit 610, or be coupled to processing circuit 610 via an input/output controller, a bridge, or other interface circuitry. Other variations of the technology are possible.

Some examples of computing device 600 include at least one memory (e.g., operating memory 620) adapted to store run-time data and at least one processor (e.g., processing circuit 610) that is adapted to execute processor-executable code that, in response to execution, enables computing device 600 to perform actions, where the actions may include, in some examples, actions for one or more methodologies or processes described herein, such as, processes described with reference to FIGS. 1-6, as described above.

In some embodiments, when the device or system include one or more sensors 690, the sensors may be configured to sense or gather data pertaining to the surrounding environment or operation of the device or system. Some exemplary sensors capable of being electronically coupled with the device or system of the present disclosure (either directly connected to the device or system of the present disclosure or remotely connected thereto) may include but are not limited to: accelerometers sensing accelerations experienced during rotation, translation, velocity/speed, location traveled, elevation gained; gyroscopes sensing movements during angular orientation and/or rotation, and rotation; altimeters sensing barometric pressure, altitude change, terrain climbed, local pressure changes, submersion in liquid; impellers measuring the amount of fluid passing thereby; Global Positioning sensors sensing location, elevation, distance traveled, velocity/speed; audio sensors sensing local environmental sound levels, or voice detection; photo/Light sensors sensing ambient light intensity, ambient, day/night, UV exposure; TV/IR sensors sensing light wavelength; temperature sensors sensing machine or motor temperature, ambient air temperature, and environmental temperature; and moisture sensors for sensing surrounding moisture levels.

The device or system of the present disclosure may include wireless communication logic coupled to sensors on the device or system. The sensors gather data and provide the data to the wireless communication logic. Then, the wireless communication logic may transmit the data gathered from the sensors to a remote device. Thus, the wireless communication logic may be part of a broader communication system, in which one or several devices or systems of the present disclosure may be networked together to report alerts and, more generally, to be accessed and controlled remotely. Depending on the types of transceivers installed in the device or system of the present disclosure, the system may use a variety of protocols (e.g., Wifi, ZigBee, MiWi, Bluetooth) for communication. In one example, each of the devices or systems of the present disclosure may have its own IP address and may communicate directly with a router or gateway. This would typically be the case if the communication protocol is WiFi.

In another example, a point-to-point communication protocol like MiWi or ZigBee is used. One or more of the device or system of the present disclosure may serve as a repeater, or the devices or systems of the present disclosure may be connected together in a mesh network to relay signals from one device or system to the next. However, the individual device or system in this scheme typically would not have IP addresses of their own. Instead, one or more of the devices or system of the present disclosure communicates with a repeater that does have an IP address, or another type of address, identifier, or credential that may be needed to communicate with an outside network. The repeater communicates with the router or gateway.

In either communication scheme, the router or gateway communicates with a communication network, such as the Internet, although in some embodiments, the communication network may be a private network that uses transmission control protocol/internet protocol (TCP/IP) and other common Internet protocols but does not interface with the broader Internet, or does so only selectively through a firewall.

The system also allows individuals to access the device or system of the present disclosure for configuration and diagnostic purposes. In that case, the individual processors or microcontrollers of the device or system of the present disclosure may be configured to act as Web servers that use a protocol like hypertext transfer protocol (HTTP) to provide an online interface that can be used to configure the device or system. In some embodiments, the systems may be used to configure several devices or systems of the present disclosure at once. For example, if several devices or systems are of the same model and are in similar locations in the same location, it may not be to configure the devices or systems individually. Instead, an individual may provide configuration information, including baseline operational parameters, for several devices or systems at once.

Various disclosed concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various disclosed embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the disclosed embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the disclosed teachings is/are used. Those skilled in the art will recognize, or be able to ascertain using no more than routine experimentation, many equivalents to the specific disclosed embodiments described herein. It is, therefore, to be understood that the foregoing embodiments are presented by way of example and that, within the scope of the appended claims and equivalents thereto, disclosed embodiments may be practiced otherwise than as specifically described and claimed. Disclosed embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the disclosed scope of the present disclosure.

The above-described embodiments can be implemented in any of numerous ways. For example, embodiments of technology disclosed herein may be implemented using hardware, software, or a combination thereof. When implemented in software, the software code or instructions can be executed on any suitable processor or collection of processors, whether provided in a single computer or distributed among multiple computers. Furthermore, the instructions or software code can be stored in at least one non-transitory computer readable storage medium.

Also, a computer or smartphone may be utilized to execute the software code or instructions via its processors may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software/instructions that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various disclosed concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. The functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Definitions, as defined and used herein, should be understood to control over dictionary definitions, definitions in documents incorporated by reference, and/or ordinary meanings of the defined terms.

“Logic”, as used herein, includes but is not limited to hardware, firmware, software, and/or combinations of each to perform a function(s) or an action(s), and/or to cause a function or action from another logic, method, and/or system. For example, based on a desired application or needs, logic may include a software-controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve on existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the method or process of the present disclosure, which may incorporate some aspects of natural phenomenon, the process or method steps are additional features that are new and useful.

The articles “a” and “an,” as used herein in the specification and in the claims, unless clearly indicated to the contrary, are to be understood to mean “at least one.” The phrase “and/or,” as used herein in the specification and in the claims (if at all), is to be understood to mean “either or both” of the elements so conjoined, i.e., elements that are conjunctively present in some cases and disjunctively present in other cases. Multiple elements listed with “and/or” are to be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A without B being present (optionally including elements other than B); in another embodiment, to B without A being present (optionally including elements other than A); in yet another embodiment, to both A and B (optionally including other elements); etc. As used herein in the specification and in the claims, “or” is to be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Terms clearly indicated to the contrary, such as “one of” or “exactly one of,” or, when used in the claims, “consisting of,” will refer to the inclusion of exactly one element of a number or list of elements. In general, the term “or” as used herein shall be interpreted as indicating alternative alternatives (i.e. “one or the other but not both”) when preceded by terms of exclusivity, such as “either,” “one of,” “a single one of,” or “exactly one of.” “Consisting substantially of,” when used in the claims, shall have its ordinary meaning as used in the field of patent law.

As used herein in the specification and in the claims, the phrase “at least one,” in reference to a list of one or more elements, is to be understood to mean at least one element selected from any one or more of the elements in the list of elements, but not always including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein in the specification and in the claims, the term “effecting” or a phrase or claim element beginning with the term “effecting” is to be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources used for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an example embodiment,” “an exemplary embodiment,” or “other embodiments,” or the like, means that a particular feature, structure, or characteristic described in connection with the embodiments is included in at least some embodiments, but not in all embodiments, of the disclosure. The various appearances “an embodiment,” “one embodiment,” “some embodiments,” “one particular embodiment,” “an example embodiment,” “an exemplary embodiment,” or “other embodiments,” or the like, are not all referring to the same embodiments. References in the specification to “an embodiment,” “one embodiment,” “some embodiments,” “one particular embodiment,” “an example embodiment,” “an exemplary embodiment,” or “other embodiments,” or the like, indicate that the embodiment described may include a particular feature, structure, or characteristic, but every embodiment may not always include the particular feature, structure, or characteristic. Moreover, such phrases are not all referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended. As used herein in the specification and claims, including as used in the examples and unless otherwise expressly specified, numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method is to be read as a limitation unless explicitly stated. It is recognizable that performing some of the steps of the method in a different order could achieve a similar result.

In the claims, as well as in the specification above, transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

In the foregoing description, certain terms have been used for brevity, clearness, and understanding. No unnecessary limitations are to be implied therefrom beyond the scope of the prior art because such terms are used for descriptive purposes and are intended to be broadly construed.

The description and illustration of various embodiments of the disclosure are examples and the disclosure is not limited to the exact details shown or described. While various embodiments of the disclosed subject matter have been described above, it is to be understood that they have been presented by way of example, and not limitation. It will be understood by those skilled in the relevant art(s) that various changes in form and details may be made therein without departing from the spirit and scope of the embodiments as defined in the appended claims. Accordingly, the breadth and scope of the disclosed subject matter is not to be limited by any of the above-described exemplary embodiments, but is to be defined in accordance with the following claims and their equivalents.

What is claimed:

1. A low Earth orbit satellite, comprising:
a deployable multilayer structural element movable from a folded or rolled launch configuration to a deployed configuration;
the deployable multilayer structural element including:
a carrier layer;
a plurality of electrodes formed on the carrier layer and arranged as an array of thin-film antenna elements;
a support substrate disposed opposite the carrier layer and separated from the plurality of electrodes by a separation distance, the support substrate providing a ground plane for the array of thin-film antenna elements; and
a thin-film solar panel system supported by the support substrate;
a deployable support structure comprising carbon fiber booms configured to uncurl from a compact launch configuration and hold the deployable multilayer structural element in the deployed configuration;
for each thin-film antenna element, a transmit path including a digital-to-analog converter and a power amplifier and a receive path including a low-noise amplifier and an analog-to-digital converter;
an onboard signal processing system coupled to the array of thin-film antenna elements through respective high-speed data links; and
a digital beamforming processor configured to:
generate a linear frequency modulated radar signal in a VHF or UHF band;
time-multiplex transmission and reception by disconnecting the transmit path from a selected thin-film antenna element during reception;
autocorrelate the reflected radar signal digitized by the analog-to-digital converters with the linear frequency modulated radar signal in real time to perform pulse compression and enhance signal-to-noise ratio; and
digitally form and steer multiple narrow radar beams over a field of view using the array of thin-film antenna elements.

2. The satellite of claim 1, wherein the respective high-speed data links comprise fiber optic links.

3. The satellite of claim 1, wherein the plurality of electrodes are printed on the carrier layer using a conductive ink.

4. The satellite of claim 3, wherein each of the plurality of electrodes is a conductive spiral.

5. The satellite of claim 1, wherein the support substrate comprises a supporting layer and a thin conductive layer overlying a surface of the supporting layer, the thin conductive layer serving as the ground plane.

6. The satellite of claim 5, wherein the thin conductive layer is a metalized layer and the supporting layer and the carrier layer each comprise one or more of polyethylene terephthalate film, nylon film, mylar film, polyamide film, and polyimide film.

7. The satellite of claim 1, wherein the array of thin-film antenna elements includes at least 1000 elements distributed over a deployed area of at least 420 m².

8. The satellite of claim 1, wherein the digital beamforming processor is reconfigurable via software updates to adapt to different radar scanning modes.

9. A space-based radar system, comprising:
a constellation of low Earth orbit (LEO) satellites comprising: a first LEO satellite and a second LEO satellite;
each LEO satellite, comprising:
a very large aperture phased array antenna comprising a ground plane and an array of thin-film antenna elements mounted on a carrier layer, a thin-film solar panel system mounted opposite the array of thin-film antenna elements, and
a digital beamforming processor coupled to the thin-film antenna elements; and
an optical intersatellite communication system that communicates with other optical intersatellite communication systems on the other LEO satellites; and
wherein at least the first LEO satellite and the second LEO satellite are configured to:
steer multiple radar beams toward a common geographic region;
receive reflected radar signals from one or more objects within the common geographic region at different look angles;
exchange radar data through the optical intersatellite communication systems; and
combine the radar data received from the different look angles to detect or track the one or more objects.

10. The system of claim 9, wherein the first LEO satellite and the second LEO satellite combine raw data from multiple sensors at multiple angles for target analysis.

11. The system of claim 9, wherein the LEO satellites are capable of direct communication with one or more ground stations.

12. The system of claim 9, further comprising:
a control system configured to receive external commands from a remote operator or an autonomous artificial intelligence module for real-time beam control and optimization.

13. The system of claim 12, wherein the control system is configured to task additional LEO satellites in the constellation to the common geographic region so that the common geographic region is observed from multiple angles to reduce terrain masking.

14. The system of claim 9, wherein the system uses Doppler variation to remove clutter and detect objects.

15. The system of claim 9, wherein multiple independent beams are formed simultaneously and are assigned to different communication channels, frequency bands, or spatial regions.

16. A method of operating a space-based radar system having a constellation of low Earth orbit satellites, the method comprising:
tasking a subset of the satellites to a geographic region of concern;
at each satellite in the subset, generating and transmitting a linear frequency modulated VHF or UHF radar signal using an array of thin-film antenna elements of a very large aperture phased array antenna toward the geographic region of concern;
time-multiplexing transmission and reception by disconnecting a transmitter from at least one of the thin-film antenna elements during reception;
digitizing received echoes using low-noise amplifiers and analog-to-digital converters associated with respective thin-film antenna elements;
performing real-time autocorrelation between the transmitted radar signal and the received echoes to perform pulse compression;
digitally forming and steering multiple narrow beams over a field of view;
communicating radar data between at least two of the satellites through optical intersatellite links; and
combining radar data received at multiple angles to detect or track an object in the geographic region of concern.

17. The method of claim 16, further comprising:
dynamically adjusting phase and amplitude weights of the thin-film antenna elements based on changing signal conditions.

18. The method of claim 16, further comprising:
fast beam hopping to cycle through a field of regard for object detection.

19. The method of claim 16, wherein the transmitted radar signal is generated over a wideband frequency range and beamforming parameters are dynamically adjusted across different frequencies.

20. The method of claim 16, further comprising:
communicating tasking information or processed radar data from one or more of the satellites to a ground station.
